(19) United States
(12) Patent Application Publication
(10) Pub. No.: US 2025/0254081 A1
(43) Pub. Date: Aug. 7, 2025

(54) REFERENCE SIGNALS FOR WIRELESS COMMUNICATION SYSTEMS

(71) Applicant: HUAWEI TECHNOLOGIES CO., LTD., Shenzhen (CN)

(72) Inventors: Peng Wang, Kista (SE); Branislav M. Popovic, Kista (SE); Fredrik Berggren, Kista (SE)

(73) Assignee: HUAWEI TECHNOLOGIES CO., LTD., Shenzhen (CN)

(21) Appl. No.: 19/030,675

(22) Filed: Jan. 17, 2025

Related U.S. Application Data
(63) Continuation of application No. PCT/EP2022/071781, filed on Aug. 3, 2022.

(51) Int. Cl. H04L 27/36; H04L 25/02; H04L 27/38

(52) U.S. Cl. CPC H04L 27/364; H04L 25/0226; H04L 27/38

(57) ABSTRACT

First and second communication devices employ reference signals for channel estimation in a communication system. The reference signals are based on modulation sequences from a set of QA modulation sequences of length L≥1. The set of QA modulation sequences includes Q subsets of modulation sequences, Q≥1, where each subset of modulation sequences comprises A modulation sequences, A≥1. A correlation between any two reference signals based on any two modulation sequences in a same subset of modulation sequences satisfies a first correlation criterion, and a correlation between any two reference signals based on any two modulation sequences in respective any two different subsets of modulation sequences satisfies a second correlation criterion.

### CROSS-REFERENCE TO RELATED APPLICATIONS

This application is a continuation of International Application No. PCT/EP2022/071781, filed on Aug. 3, 2022, the disclosure of which is hereby incorporated by reference in its entirety.

### FIELD

Embodiments of the present disclosure relate to reference signals for wireless communication systems implemented by a first communication device and a second communication device employing the reference signals.

### BACKGROUND

Accurate channel state information (CSI) is crucial for most wireless communication systems, such as for Third Generation Partnership Project (3GPP) 5G, in guaranteeing efficient and reliable data transmissions between a transmitter and a receiver. CSI allows the transmitter to have proper precoding design, modulation and coding scheme (MCS) selection, power control, user scheduling, etc., that are adaptive to the dynamically varying wireless channels, and also allows the receiver to have correct signal detection and interference avoidance.

In time-division duplexed (TDD) cellular communication systems it is commonly assumed that the uplink (UL) and downlink (DL) propagation channels between a user equipment (UE) and a base station (BS)/transmit-receive point (TRP) are identical to each other. That is, the channel reciprocity holds. The CSI at the BS/TRP is acquired by letting the UE transmit a sounding reference signal (SRS) to the BS/TRP. The BS/TRP then estimates the UL channel based on the received SRS from the UE and interprets it as the DL channel for the transmitter design of future DL data transmissions.

### SUMMARY

Embodiments of the present disclosure provide solutions which mitigate or solve drawbacks and problems of conventional solutions, thereby alleviating the channel aging problem, and solving the intra-/inter-cell cross reference signal interference problem.

According to a first aspect of the present disclosure, the abovementioned problems are solved with a first communication device that is configured to:
obtain a reference signal, wherein the reference signal is based on a modulation sequence from a set of QA modulation sequences of length L≥1, the set of QA modulation sequences comprising Q subsets of modulation sequences, Q≥1, each subset of modulation sequences comprising A modulation sequences, A≥1, wherein a correlation between any two reference signals based on any two modulation sequences in a same subset of modulation sequences satisfies a first correlation criterion, wherein a correlation between any two reference signals based on any two modulation sequences in respective any two different subsets of modulation sequences satisfies a second correlation criterion, and wherein the correlation between any two reference signals based on any two modulation sequences in a same subset of modulation sequences is lower than the correlation between any two reference signals based on any two modulation sequences in respective any two different subsets of modulation sequences; and
transmit the reference signal.

An advantage of the first communication device according to the first aspect is that the set of QA modulation sequences can be adopted to generate an increased number of reference signals that is Q times larger than existing reference signal generation in the same time and frequency resources. The increased number of reference signals can be used to support a larger number of first communication devices in each cell in the same time and frequency resources thereby achieving a higher system throughput. Another advantage is that the same number of first communication devices in each cell may be supported with a shorter reference signal transmission period in the same frequency resources thereby alleviating the channel aging problem. Yet another advantage is that the same number of first communication devices in each cell can be supported in reduced time and frequency resources with the same reference signal transmission period such that the reference signal transmissions in adjacent cells can be coordinated to occupy orthogonal time and frequency resources thereby alleviating the inter-cell cross interference.

In an implementation form of the first communication device according to the first aspect, the first correlation criterion defines that a reference signal based on a modulation sequence in a subset of modulation sequences is orthogonal to a consecutive number of cyclically shifted versions of another reference signal based on another modulation sequence in the same subset of modulation sequences.

An advantage with this implementation form is that according to the first correlation criterion, the periodic cross-correlation function of two reference signals based on any two modulation sequences in a same subset of modulation sequences is zero under a consecutive number cyclically shifted delay offsets. Consequently, the A reference signals based on all the A modulation sequences in a same subset of modulation sequence have a zero correlation zone (ZCZ) with length equal to the number of consecutive cyclically shifted delay offsets under which their periodic cross-correlation functions are zero. When reference signals based on any of the modulation sequences in the same subset of modulation sequences are transmitted from the same or different first communication devices with proper timing advance (TA) adjustment, and the maximum delay of the wireless channels experienced by the reference signals is not larger than the length of the ZCZ for all the reference signals based on all the modulation sequences in the same subset of modulation sequences, the interference between these reference signals at the receiver can be completely avoided which means that the wireless channels experienced by the reference signals can be estimated accurately.

In an implementation form of the first communication device according to the first aspect, the second correlation criterion defines that a reference signal based on a modulation sequence in a subset of modulation sequences has a cross correlation lower than a predetermined threshold to a consecutive number of cyclically shifted versions of another reference signal based on another modulation sequence in a different subset of modulation sequences.

An advantage with this implementation form is that according to the second correlation criterion, the amplitude of the periodic cross-correlation function of two reference signals based on any two modulation sequences in any two different subsets of modulation sequences is lower than a predetermined threshold under a consecutive number of cyclically shifted delay offsets. Consequently, all the QA reference signals based on all the QA modulation sequences in the set of modulation sequence have a low correlation zone (LCZ) of length equal to the minimum of the number of consecutive number of cyclically shifted delay offsets under which the amplitudes of their periodic cross-correlation functions are lower than the predetermined threshold and the ZCZ lengths of the A reference signals based on all the A modulation sequences in each of the Q subsets of modulation sequences. When reference signals based on any of the modulation sequences in the set of QA modulation sequences are transmitted from the same or different first communication devices with proper TA adjustment, and the maximum delay of the wireless channels experienced by the reference signals is no larger than the length of the LCZ for all the reference signals based on all the modulation sequences in the set of modulation sequences, the interference between the reference signals at the receiver is low, and the LCZ property of all the reference signals based on all the modulation sequences in the set of modulation sequences can guarantee that the interference among these reference signals at the receiver, also referred to as intra-cell cross interference, can be efficiently separated by using a compressive sensing (CS) based channel estimation method, which means that the wireless channels experienced by the reference signals can be estimated accurately even when intra-cell cross interference is present.

In an implementation form of the first communication device according to the first aspect, at least one modulation sequence in the set of QA modulation sequences is based on a first sequence in a set of first sequences of length A, a second sequence in a set of second sequences of length B≥1 and a third sequence of length L, wherein the set of first sequences comprises Q subsets of first sequences, each subset of first sequences comprising A constant-envelope sequences, where all A constant-envelope sequences are mutually orthogonal to each other, wherein the set of second sequences comprises Q constant-envelope sequences, where a correlation between any two second sequences in the set of Q second sequences satisfies a third correlation criterion, and wherein the third sequence is a constant-envelope sequence.

An advantage with this implementation form is that this method of modulation sequence construction guarantees that the first correlation criterion is fulfilled for all the A reference signals based on all the A modulation sequences in each of the Q subsets of modulation sequences, and that the second correlation criterion is fulfilled for all the QA reference signals based on all the QA modulation sequences in the whole set of modulation sequences. In particular, the mutually orthogonal property of all the A first sequences in each of the Q subsets of first sequences guarantees that the reference signals based on the corresponding A modulation sequences in each of the Q subsets of modulation sequences satisfy the first correlation criterion. The third correlation criterion regarding the second sequences also guarantees that the reference signals based on the corresponding QA modulation sequences in the whole set of modulation sequences satisfy the second correlation criterion.

In an implementation form of the first communication device according to the first aspect, a modulation sequence in the set of QA modulation sequences is based on element-by-element multiplication of a periodic repetition of a first sequence, a periodic repetition of a second sequence and a third sequence.

An advantage with this implementation form is that an explicit and efficient method of generating the modulation sequences in the set of modulation sequences is provided. In particular, the third sequence has the same length L as the length of the modulation sequence, while the first and second sequences have shorter lengths than the length of the modulation sequence. To generate the modulation sequence, the first and second sequences firstly need to be periodically extended to the same length L as that of the modulation sequence, and then the element-by-element multiplication operation can be performed.

In an implementation form of the first communication device according to the first aspect, first sequences in each subset of first sequences are columns of an A×A constant-envelope orthogonal matrix, or based on element-by-element multiplication between columns of an A×A constant-envelope orthogonal matrix and a cover sequence, wherein the A×A constant-envelope orthogonal matrix is any of: a A×A discrete Fourier transform (DFT) matrix, a A×A Hadamard matrix, a A×A matrix with its columns being different cyclically shifted versions of a constant-amplitude zero auto-correlation (CAZAC) sequence of length A including Zadoff-Chu (ZC) sequence, or a A×A matrix with its columns being different cyclically shifted versions of a modulable CAZAC (mCAZAC) sequence of length A, and wherein the cover sequence is a constant-envelope sequence of length A that is the same for all the first sequences in each subset of first sequences, and is the same or different for different subsets of first sequences.

An advantage with this implementation form is that the constructed A first sequences in each of the Q subsets of first sequences can be guaranteed to be mutually orthogonal to each other, which in turn guarantees that the first correlation criterion is fulfilled among all the A reference signals based on all the A modulation sequences in each of the Q subsets of modulation sequences.

In an implementation form of the first communication device according to the first aspect, the second sequence is common for all modulation sequences in a same subset of modulation sequences and different for modulation sequences from different subsets of modulation sequences, where the length of the second sequence B is an integer being a multiple of A and a factor of L, and wherein the second sequence is any of: an all “1” sequence of length B, a CAZAC/mCAZAC sequence of length B, a CAZAC/mCAZAC sequence having a length shorter than B that is periodically extended to length B, or a CAZAC/mCAZAC sequence of a length longer than B that is truncated to length B.

An advantage with this implementation form is that the constructed second sequences in the set of Q second sequences can be guaranteed to satisfy the third correlation criterion. In addition, by letting the length of the second sequence B to be an integer being a multiple of A and a factor of L, the QA reference signals based on the QA modulation sequences in the whole set of modulation sequences can be guaranteed to satisfy the second correlation criterion. Furthermore, the selection of different (periodically extended/truncated) CAZAC/mCAZAC sequences for the second sequences may lead to different peak-to-average power ratios (PAPRs) of the resultant reference signals. Hence, an additional advantage with this implementation form is that low PAPRs of the resultant reference signals can be achieved by selecting proper (periodically extended/truncated) CAZAC/mCAZAC sequences as the second sequences. For example, when the second sequences are selected as ZC sequences of a prime length close to B, there will be about B candidate ZC root indices, and the second sequences can be selected to be ZC sequences with optimized root indices such that low-PAPR reference signals can be obtained.

In an implementation form of the first communication device according to the first aspect,
a length B of the second sequence is predefined; or
the first communication device is configured to receive a control signal indicating the length B of the second sequence, wherein the length B of the second sequence is indicated by a bit string of length ┌log₂(N_{B})┐, where the operator [x] returns the minimum integer that is no less than x, and N_{B} is the number of integers in the set of integers that are a multiple of A and a factor of L, or the number of integers in a predefined subset of the set of integers that are a multiple of A and a factor of L.

An advantage with this implementation form is that the first communication device can obtain necessary signaling information to determine the length of the second sequence B for generating a modulation sequence and in turn a reference signal.

In an implementation form of the first communication device according to the first aspect, the third correlation criterion defines that a second sequence in the set of second sequences has a cross correlation lower than a predetermined threshold to all the cyclically shifted versions of another second sequence in the set of second sequences.

An advantage with this implementation form is that according to the third correlation criterion, the amplitude of the periodic cross-correlation function of any two second sequences in the set of Q second sequences is lower than a predetermined threshold under all cyclically shifted delay offsets. This, together with the condition that the length of the second sequence B is selected to be an integer being a multiple of the number of modulation sequences in each subset of modulation sequence A and a factor of the length of the modulation sequence L, jointly guarantee that all the QA reference signals based on all the QA modulation sequences in the set of modulation sequences have a LCZ of a certain length in their periodic cross-correlation functions. When reference signals based on any of the modulation sequences in the set of QA modulation sequences are transmitted from the same or different first communication devices with proper TA adjustment, and the maximum delay of the wireless channels experienced by these reference signals is no larger than the length of the LCZ of all the reference signals based on all the modulation sequences in the set of modulation sequences, the LCZ property of these reference signals can guarantee that the interference among them at the receiver, also referred to as intra-cell cross interference, is low and can be efficiently separated by using a CS based channel estimation method, so that the wireless channels experienced by these reference signals can be estimated accurately even when intra-cell cross interference is present.

In an implementation form of the first communication device according to the first aspect, the third sequence is any of a CAZAC/mCAZAC sequence of length L, a CAZAC/mCAZAC sequence of length shorter than L that is periodically extended to length L, or a CAZAC/mCAZAC sequence of length longer than L that is truncated to length L.

An advantage with this implementation form is that the constructed third sequence can be guaranteed to have a constant envelope. In addition, by selecting different third sequences by any of the abovementioned methods, e.g., based on different CAZAC/mCAZAC sequences or in particular ZC sequences with different root indices, multiple sets of modulation sequences can be constructed for generating multiple sets of reference signals for use in different cells, and the cross correlation between the reference signals in different sets of reference signals is low.

In an implementation form of the first communication device according to the first aspect, the first communication device is configured to
transmit the reference signal by mapping the modulation sequence on a set of L subcarriers among N consecutive subcarriers, N≥L, wherein the N consecutive subcarriers are divided into t subbands comprising an equal number of consecutive subcarriers, and wherein the set of L subcarriers comprise A subcarriers from each subband and the positions of the A subcarriers in each subband are the same for all the t subbands.

An advantage with this implementation form is that the frequency resources occupied by the modulation sequence exhibit a block-repetitive structure, and this block-repetitive structure can guarantee that a reference signal based on any modulation sequence in the set of modulation sequences is orthogonal to a consecutive number of the cyclically shifted versions of itself, i.e., each reference signal has a zero auto-correlation zone (ZAZ) with length equal to the number of consecutive cyclically shifted values under which its periodic auto-correlation function is zero. When such a reference signal is transmitted over a wireless channel with it maximum delay no larger than the length of this ZAZ, the channel experienced by the reference signal can be accurately estimated at the receiver e.g., by first periodically correlating the received reference signal with a reference signal generated locally that is identical to the transmitted reference signal, and then adopting a proper detection window to the correlation output, whose length is no less than the maximum channel delay and no larger than the ZAZ length. The estimated channel of the transmitted reference signal can be obtained from the detection window output.

In an implementation form of the first communication device according to the first aspect,
the value of Q is predefined; or
the first communication device is configured to receive a control signal indicating the value of Q.

An advantage with this implementation form is that the first communication device can obtain necessary signaling information to determine the number of subsets of first sequences as well as the number of subsets of modulation sequences and the number of subsets of reference signals, such that the identity of the modulation sequence can be correctly determined from a control signal indicating an identity of the modulation sequence.

In an implementation form of the first communication device according to the first aspect, the first communication device is configured to receive a control signal indicating an identity of the modulation sequence, wherein the identity of the modulation sequence is indicated by
a single bit string of ┌log₂ (N_{group}QA)┐ bits, where Ngᵣₒᵤₚ is a number of reference signal groups defined in the communication system (500); or
two bit strings of lengths ┌log₂(N_{group})┐ and ┌log₂(QA)┐, respectively, where the first bit string indicates a reference signal group index, and the second bit string indicates an index of a modulation sequence in a set of modulation sequences associated with the reference signal group index; or three bit strings of length ┌log₂(N_{group})┐, ┌log₂(Q)┐ and ┌log₂(A)┐, respectively, where the first bit string indicates a reference signal group index, the second bit string indicates an index of a subset of modulation sequences in a set of modulation sequences associated with the reference signal group index, and the third bit string indicates an index of a modulation sequence in a subset of modulation sequences.

An advantage with this implementation form is that the identity of the modulation sequence can be indicated by a second communication device to the first communication device, such that the first communication device can generate the correct modulation sequence and in turn the correct reference signal. The implementation form also provides the identity signaling in several flexible and efficient ways, such that the signaling overheads are low.

According to a second aspect of the present disclosure, the abovementioned problems are solved and other objectives are achieved with a second communication device that is configured to
receive a reference signal;
obtain a modulation sequence from a set of QA modulation sequences of length L≥1, the set of QA modulation sequences comprising Q subsets of modulation sequences, Q≥1, each subset of modulation sequences comprising A modulation sequences, A≥1, wherein a correlation between any two reference signals based on any two modulation sequences in a same subset of modulation sequences satisfies a first correlation criterion, wherein a correlation between any two reference signals based on any two modulation sequences in respective any two different subsets of modulation sequences satisfies a second correlation criterion, and wherein the correlation between any two reference signals based on any two modulation sequences in a same subset of modulation sequences is lower than the correlation between any two reference signals based on any two modulation sequences in respective any two different subsets of modulation sequences; and
estimate a wireless channel based on the received reference signal and the modulation sequence.

An advantage of the second communication device according to the second aspect is that the set of QA modulation sequences can be adopted to generate an increased number of reference signals that is Q times larger than existing reference signal generation in the same time and frequency resources. The increased number of reference signals can be used to support a larger number of first communication devices in each cell in the same time and frequency resources thereby achieving a higher system throughput. Another advantage is that the same number of first communication devices in each cell may be supported with a shorter reference signal transmission period in the same frequency resources thereby alleviating the channel aging problem. Yet another advantage is that the same number of first communication devices in each cell can be supported in reduced time and frequency resources with the same reference signal transmission period such that the reference signal transmissions in adjacent cells can be coordinated to occupy orthogonal time and frequency resources thereby alleviating the inter-cell cross interference.

In an implementation form of the second communication device according to the second aspect, the first correlation criterion defines that a reference signal based on a modulation sequence in a subset of modulation sequences is orthogonal to a consecutive number of cyclically shifted versions of another reference signal based on another modulation sequence in the same subset of modulation sequences.

An advantage with this implementation form is that according to the first correlation criterion, the periodic cross-correlation function of any two reference signals based on any two modulation sequences in a same subset of modulation sequences is zero under a consecutive number cyclically shifted delay offsets. Consequently, all the A reference signals based on all the A modulation sequences in a same subset of modulation sequence have a ZCZ with length equal to the number of consecutive cyclically shifted delay offsets under which their periodic cross-correlation functions are zero. When reference signals based on any of the modulation sequences in the same subset of modulation sequences are transmitted from the same or different first communication devices with proper TA adjustment, and the maximum delay of the wireless channels experienced by these reference signals is not larger than the length of the ZCZ for all the reference signals based on all the modulation sequences in the same subset of modulation sequences, the interference between these reference signals at the receiver can be completely avoided which means that the wireless channels experienced by the reference signals can be estimated accurately.

In an implementation form of the second communication device according to the second aspect, the second correlation criterion defines that a reference signal based on a modulation sequence in a subset of modulation sequences has a cross-correlation lower than a predetermined threshold to a consecutive number of cyclically shifted versions of another reference signal based on another modulation sequence in a different subset of modulation sequences.

An advantage with this implementation form is that according to the second correlation criterion, the amplitude of the periodic cross-correlation function of any two reference signals based on any two modulation sequences in any two different subsets of modulation sequences is lower than a predetermined threshold under a consecutive number of cyclically shifted delay offsets. Consequently, all the QA reference signals based on all the QA modulation sequences in the set of modulation sequence have a LCZ of length equal to the minimum of the number of consecutive number of cyclically shifted delay offsets under which the amplitudes of their periodic cross-correlation functions are lower than the predetermined threshold and the ZCZ lengths of the A reference signals based on all the A modulation sequences in each of the Q subsets of modulation sequences. When reference signals based on any of the modulation sequences in the set of QA modulation sequences are transmitted from the same or different first communication devices with proper TA adjustment, and the maximum delay of the wireless channels experienced by these reference signals is no larger than the length of the LCZ for all the reference signals based on all the modulation sequences in the set of modulation sequences, the interference between the reference signals at the receiver is low, and the LCZ property of all the reference signals based on all the modulation sequences in the set of modulation sequences can guarantee that the interference among these reference signals at the receiver, also referred to as intra-cell cross interference, can be efficiently separated by using a CS based channel estimation method, which means that the wireless channels experienced by the reference signals can be estimated accurately even when intra-cell cross interference is present.

In an implementation form of the second communication device according to the second aspect, at least one modulation sequence in the set of QA modulation sequences is based on a first sequence in a set of first sequences of length A, a second sequence in a set of second sequences of length B≥1 and a third sequence of length L, wherein the set of first sequences comprises Q subsets of first sequences, each subset of first sequences comprising A constant-envelope sequences, where all A constant-envelope sequences are mutually orthogonal to each other, wherein the set of second sequences comprises Q constant-envelope sequences, where a correlation between any two second sequences in the set of Q second sequences satisfies a third correlation criterion, and wherein the third sequence is a constant-envelope sequence.

An advantage with this implementation form is that this method of modulation sequence construction guarantees that the first correlation criterion is fulfilled for all the A reference signals based on all the A modulation sequences in each of the Q subsets of modulation sequences, and that the second correlation criterion is fulfilled for all the QA reference signals based on all the QA modulation sequences in the whole set of modulation sequences. In particular, the mutually orthogonal property of all the A first sequences in each of the Q subsets of first sequences guarantees that the A reference signals based on the corresponding A modulation sequences in each of the Q subsets of modulation sequences satisfy the first correlation criterion. The third correlation criterion regarding the second sequences also guarantees that the QA reference signals based on the corresponding QA modulation sequences in the whole set of modulation sequences satisfy the second correlation criterion.

In an implementation form of the second communication device according to the second aspect, a modulation sequence in the set of QA modulation sequences is based on element-by-element multiplication of a periodic repetition of a first sequence, a periodic repetition of a second sequence and a third sequence.

An advantage with this implementation form is that an explicit and efficient method of generating the modulation sequences in the set of modulation sequences is provided. In particular, the third sequence has the same length L as the length of the modulation sequence, while the first and second sequences have shorter lengths than the length of the modulation sequence. To generate the modulation sequence, the first and second sequences firstly need to be periodically extended to the same length L as that of the modulation sequence, and then the element-by-element multiplication operation can be performed.

In an implementation form of the second communication device according to the second aspect, first sequences in each subset of first sequences are columns of an A×A constant-envelope orthogonal matrix, or based on element-by-element multiplication between columns of an A×A constant-envelope orthogonal matrix and a cover sequence, wherein the A×A constant-envelope orthogonal matrix is any of: a A×A DFT matrix, a A×A Hadamard matrix, a A×A matrix with its columns being different cyclically shifted versions of a CAZAC sequence of length A including ZC sequence, or a A×A matrix with its columns being different cyclically shifted versions of a mCAZAC sequence of length A, and wherein the cover sequence is a constant-envelope sequence of length A that is the same for all the first sequences in each subset of first sequences, and is the same or different for different subsets of first sequences.

An advantage with this implementation form is that the constructed A first sequences in each of the Q subsets of first sequences can be guaranteed to be mutually orthogonal to each other, which in turn guarantees that the first correlation criterion is fulfilled among all the A reference signals based on all the A modulation sequences in each of the Q subsets of modulation sequences.

In an implementation form of the second communication device according to the second aspect, the second sequence is common for all modulation sequences in a same subset of modulation sequences and different for modulation sequences from different subsets of modulation sequences, where the length of the second sequence B is an integer being a multiple of A and a factor of L, and wherein the second sequence is any of: an all “1” sequence of length B, a CAZAC/mCAZAC sequence of length B, a CAZAC/mCAZAC sequence having a length shorter than B that is periodically extended to length B, or a CAZAC/mCAZAC sequence of a length longer than B that is truncated to length B.

An advantage with this implementation form is that the constructed second sequences in the set of Q second sequences can be guaranteed to satisfy the third correlation criterion. In addition, by letting the length of the second sequence B to be an integer being a multiple of A and a factor of L, the QA reference signals based on the QA modulation sequences in the whole set of modulation sequences can be guaranteed to satisfy the second correlation criterion. Furthermore, the selection of different (periodically extended/truncated) CAZAC/mCAZAC sequences for the second sequences may lead to different PAPRs of the resultant reference signals. Hence, an additional advantage with this implementation form is that low PAPRs of the resultant reference signals can be achieved by selecting proper (periodically extended/truncated) CAZAC/mCAZAC sequences as the second sequences. For example, when the second sequences are selected as ZC sequences of a prime length close to B, there will be about B candidate ZC root indices, and the second sequences can be selected to be ZC sequences with optimized root indices such that low-PAPR reference signals can be obtained.

In an implementation form of the second communication device according to the second aspect, a length B of the second sequence is predefined; or
the second communication device is configured to transmit a control signal indicating the length B of the second sequence, wherein the length B of the second sequence is indicated by a bit string of length ┌log₂(N_{B})┐, where N_{B} is the number of integers in the set of integers that are a multiple of A and a factor of L, or the number of integers in a predefined subset of the set of integers that are a multiple of A and a factor of L.

An advantage with this implementation form is that the second communication device can transmit necessary signaling information to the first communication device for the latter to determine the length of the second sequence B for generating a modulation sequence and in turn a reference signal.

In an implementation form of the second communication device according to the second aspect, the third correlation criterion defines that a second sequence in the set of second sequences has a cross-correlation lower than a predetermined threshold to all the cyclically shifted versions of another sequence in the set of second sequences.

An advantage with this implementation form is that according to the third correlation criterion, the amplitude of the periodic cross-correlation function of any two second sequences in the set of Q second sequences is lower than a predetermined threshold under all cyclically shifted delay offsets. This, together with the condition that the length of the second sequence B is selected to be an integer being a multiple of the number of modulation sequences in each subset of modulation sequence A and a factor of the length of the modulation sequence L, jointly guarantee that all the QA reference signals based on all the QA modulation sequences in the set of modulation sequences have a LCZ of a certain length in their periodic cross-correlation functions. When reference signals based on any of the modulation sequences in the set of QA modulation sequences are transmitted from the same or different first communication devices with proper TA adjustment, and the maximum delay of the wireless channels experienced by these reference signals is no larger than the length of the LCZ of all the reference signals based on all the modulation sequences in the set of modulation sequences, the LCZ property of these reference signals can guarantee that the interference among them at the receiver, also referred to as intra-cell cross interference, is low and can be efficiently separated by using a CS based channel estimation method, so that the wireless channels experienced by these reference signals can be estimated accurately even when intra-cell cross interference is present.

In an implementation form of the second communication device according to the second aspect, the third sequence is any of a CAZAC/mCAZAC sequence of length L, a CAZAC/mCAZAC sequence of length shorter than L that is periodically extended to length L, or a CAZAC/mCAZAC sequence of length longer than L that is truncated to length L.

An advantage with this implementation form is that the constructed third sequence can be guaranteed to have constant envelope. In addition, by selecting different third sequences by any of the abovementioned methods, e.g., based on different CAZAC/mCAZAC sequences or in particular ZC sequences with different root indices, multiple sets of modulation sequences can be constructed for generating multiple sets of reference signals for use in different cells, and the cross correlation between the modulation sequences in different sets of modulation sequences is low.

In an implementation form of the second communication device according to the second aspect, the second communication device is configured to
receive the reference signal on a set of L subcarriers among N consecutive subcarriers, N≥L, wherein the N consecutive subcarriers are divided into t subbands comprising an equal number of consecutive subcarriers, and wherein the set of L subcarriers comprise A subcarriers from each subband and the positions of the A subcarriers in each subband are the same for all the t subbands.

An advantage with this implementation form is that the frequency resources occupied by the modulation sequences exhibit a block-repetitive structure, and this block-repetitive structure can guarantee that a reference signal based on any modulation sequence in the set of modulation sequences is orthogonal to a consecutive number of the cyclically shifted versions of itself, i.e., each reference signal based on each modulation sequence has a zero auto-correlation zone (ZAZ) with length equal to the number of consecutive cyclically shifted values under which its periodic auto-correlation function is zero. When the reference signal is transmitted over a wireless channel with it maximum delay no larger than the length of this ZAZ, the channel experienced by the reference signal can be accurately estimated at the receiver e.g., by first periodically correlating the received reference signal with a reference signal generated locally that is identical to the transmitted reference signal, and then adopting a proper detection window to the correlation output, whose length is no less than the maximum channel delay and no larger than the ZAZ length. The estimated channel of the transmitted reference signal can then be obtained from the detection window output.

In an implementation form of the second communication device according to the second aspect,
the value of Q is predefined; or
the second communication device is configured to transmit a control signal indicating the value of Q.

An advantage with this implementation form is that the second communication device can transmit necessary signaling information to the first communication device for the latter to determine the number of subsets of first sequences as well as the number of subsets of modulation sequences and the number of subsets of reference signals, such that the identity of the modulation sequence can be correctly determined from a control signal indicating an identity of the modulation sequence.

In an implementation form of the second communication device according to the second aspect, the second communication device is configured to transmit a control signal indicating an identity of the modulation sequence, wherein the identity of the modulation sequence is indicated by
a single bit string of ┌log₂(N_{group}QA)┐ bits, where N_{group} is a number of reference signal groups defined in the communication system (500); or
two bit strings of lengths ┌log₂(N_{group})┐ and ┌log₂(QA)┐, respectively, where the first bit string indicates a reference signal group index, and the second bit string indicates an index of a modulation sequence in a set of modulation sequences associated with the reference signal group index; or
three bit strings of length ┌log₂(N_{group})┐, ┌log₂(Q)┐ and ┌log₂(A)┐, respectively, where the first bit string indicates a reference signal group index, the second bit string indicates an index of a subset of modulation sequences in a set of modulation sequences associated with the reference signal group index, and the third bit string indicates an index of a modulation sequence in a subset of modulation sequences.

An advantage with this implementation form is that the identity of the modulation sequence can be indicated by the second communication device to the first communication device, such that the first communication device can generate the correct modulation sequence and in turn the correct reference signal. The implementation form also provides the identity signaling in several flexible and efficient ways, such that the signaling overheads are low.

According to a third aspect of the present disclosure, the above mentioned problems are solved and other objectives are achieved with a method for a first communication device, the method comprises
obtaining a reference signal, wherein the reference signal is based on a modulation sequence from a set of QA modulation sequences of length L≥1, the set of QA modulation sequences comprising Q subsets of modulation sequences, Q≥1, each subset of modulation sequences comprising A modulation sequences, A≥1, wherein a correlation between any two reference signals based on any two modulation sequences in a same subset of modulation sequences satisfies a first correlation criterion, wherein a correlation between any two reference signals based on any two modulation sequences in respective any two different subsets of modulation sequences satisfies a second correlation criterion, and wherein the correlation between any two reference signals based on any two modulation sequences in a same subset of modulation sequences is lower than the correlation between any two reference signals based on any two modulation sequences in respective any two different subsets of modulation sequences; and
transmitting the reference signal.

The method according to the third aspect can be extended into implementation forms corresponding to the implementation forms of the first communication device according to the first aspect. Hence, an implementation form of the method comprises the features of the corresponding implementation form of the first communication device.

The advantages of the methods according to the third aspect are the same as those for the corresponding implementation forms of the first communication device according to the first aspect.

According to a fourth aspect of the present disclosure, the above mentioned problems are solved and other objectives are achieved with a method for a second communication device, the method comprises
receiving a reference signal;
obtaining a modulation sequence from a set of QA modulation sequences of length L≥1, the set of QA modulation sequences comprising Q subsets of modulation sequences, Q≥1, each subset of modulation sequences comprising A modulation sequences, A≥1, wherein a correlation between any two reference signals based on any two modulation sequences in a same subset of modulation sequences satisfies a first correlation criterion, wherein a correlation between any two reference signals based on any two modulation sequences in respective any two different subsets of modulation sequences satisfies a second correlation criterion, and wherein the correlation between any two reference signals based on any two modulation sequences in a same subset of modulation sequences is lower than the correlation between any two reference signals based on any two modulation sequences in respective any two different subsets of modulation sequences; and
estimating a wireless channel based on the received reference signal and the modulation sequence.

The method according to the fourth aspect can be extended into implementation forms corresponding to the implementation forms of the second communication device according to the second aspect. Hence, an implementation form of the method comprises the features of the corresponding implementation form of the second communication device.

The advantages of the methods according to the fourth aspect are the same as those for the corresponding implementation forms of the second communication device according to the second aspect.

Embodiments of the present disclosure also relate to a computer program, characterized in program code, which when run by at least one processor that causes the at least one processor to execute any method according to embodiments of the present disclosure. Further, embodiments of the present disclosure also relate to a computer program product comprising a non-transitory, tangible, computer readable medium and the mentioned computer program, wherein the computer program is included in the computer readable medium, and may comprise one or more from the group of: read-only memory (ROM), programmable ROM (PROM), erasable PROM (EPROM), flash memory, electrically erasable PROM (EEPROM), hard disk drive, etc.

Further applications and advantages of embodiments of the present disclosure will be apparent from the following detailed description.

### BRIEF DESCRIPTION OF THE DRAWINGS

The appended drawings are intended to clarify and explain different embodiments of the present disclosure, in which:

FIG. 1 depicts a first communication device according to embodiments of the present disclosure;

FIG. 2 depicts a flow chart of a method for a first communication device according to embodiments of the present disclosure;

FIG. 3 depicts a second communication device according to embodiments of the present disclosure;

FIG. 4 depicts a flow chart of a method for a second communication device according to embodiments of the present disclosure;

FIG. 5 illustrates a communication system according to embodiments of the present disclosure;

FIG. 6 illustrates common frequency resources for reference signals;

FIG. 7 depicts a signaling diagram illustrating control signaling according to embodiments of the present disclosure;

FIGS. 8a-8c depicts some performance results of embodiments of the present disclosure; and

FIGS. 9a-9c depicts some further performance results of embodiments of the present disclosure.

### DETAILED DESCRIPTION

The UL SRS-based channel estimation mechanism previously described above suffers from two main problems, i.e., the channel aging problem and the interference problem. The channel aging problem is caused by the dynamic nature of the wireless propagation channels. During the time gap between the UL SRS transmission and DL data transmission, the channel may vary due to the UE mobility and/or the change of the environment around the UE or BS/TRP, causing a mismatch between the channels experienced by the UL SRS and DL data. Such a mismatch is more pronounced when the time gap is large and/or the UE mobility is high. Consequently, the DL precoding design at the BS/TRP will become inefficient and cause sever interference between the data streams for a same or different UEs at the UE receivers, which significantly degrades the achievable DL throughput of the communication system. To guarantee efficient transmission of DL data based on UL channel estimation, it is usually required to keep this time gap as short as possible, and so a short SRS transmission period is desired to avoid severe channel aging.

The interference problem is caused by the concurrent transmissions of multiple SRSs over the same time and frequency resources. In a cellular communication system containing multiple cells and multiple UEs per cell, the allocated SRS time-frequency resources are usually kept as small as possible so as to leave more time-frequency resources for UL/DL data transmissions. Hence, it is impossible to allocate dedicated time-frequency resources for each SRS, and the concurrent transmissions of multiple SRSs is inevitable.

In the existing 5G New Radio (NR) wireless communication systems with orthogonal frequency division multiplexing (OFDM) modulation, the Rel-16/Rel-17 NR SRSs for each cell are constructed by dividing a given SRS frequency band of N consecutive subcarriers into K_{TC} combs, generating a number of n_{SRS}^{cs,max} modulation sequences by a common cyclically repeated ZC sequence with n_{SRS}^{cs,max} equidistant phase rotations, and then mapping them to the subcarriers of each comb, where the i-th (i=0, 1, . . . , n_{SRS}^{cs,max}−1) modulation sequence is given by

$${c}_{n} ( u ) = {W}_{{n}_{SRS}^{cs , max}}^{- nu} \cdot {a}_{r} ( u ) , u = 0 , 1 , … , N / {K}_{TC} - 1 , n = 0 , 1 , … , {n}_{SRS}^{cs , max} - 1 , \qquad ( 1 )$$

with

$${W}_{{n}_{SRS}^{cs , max}} = {e}^{- \sqrt{- 1} \frac{2 π}{{n}_{SRS}^{cs , max}}}$$

and aᵣ (u) a cyclically repeated ZC sequence of a certain root index r defined in the specification and length being the maximum prime number no larger than the number of subcarriers per comb, N/K_{TC}.

Such a construction results in that the generated n_{SRS}^{cs,max}K_{TC} SRSs per cell over the K_{TC} combs have a ZCZ of length

$${D}_{ZCZ} = \frac{N}{{n}_{SRS}^{cs , max} {K}_{TC}} .$$

When these n_{SRS}^{cs,max}K_{TC} SRSs are concurrently transmitted by the same or different UEs in a same cell with proper TA adjustment, the conventional matched filtering based channel estimation with a proper window of length no larger than the ZCZ length can be applied to avoid the intra-cell SRS interference between them, provided that the maximum channel delay Lₘₐₓ of the channels experienced by these SRSs is no larger than the selected window length. However, the Rel-16/Rel-17 SRS can support orthogonal transmission of at most n_{SRS}^{cs,max}K_{TC} concurrent SRSs over the given SRS frequency band. When there are E>n_{SRS}^{cs,max}K_{TC} UEs in each cell, these UEs need to be divided into

$$⌈ \frac{E}{{n}_{SRS}^{cs , max} {K}_{TC}} ⌉$$

groups and reuse these n_{SRS}^{cs,max}K_{TC} SRSs in a TDM manner, i.e., a same SRS is transmitted by different UEs, or by a same UE from different antenna ports, over different OFDM symbols, to avoid intra-cell SRS interference, which implies a longer SRS period and in turn more severe channel aging problem. In addition, since the SRS time-frequency resource allocation in adjacent cells are the same, the inter-cell cross-SRS interference is unavoidable.

The inter-cell cross-SRS interference problem is even more severe in the coherent joint transmission (CJT) scenario among multiple BSs/TRPs, where a coordinated TRP may need to estimate the channel of a UE that is far from it in an adjacent cell by receiving a SRS sent by this far UE, while suffering from strong interference from another SRS sent by another UE that is near it in its own cell. Hence the resultant channel estimation error can be very large, which degrades the CJT performance. To solve the sever interference problem for CJT, one possible approach is to allow the adjacent cells to coordinate their SRS resource allocation, i.e., to jointly perform orthogonal SRS resource allocation for UEs. However, in this case the available orthogonal SRS resource for each cell will be reduced, which may lead to a longer SRS period needed to allow for the TDM based transmission between UEs in one cell, and in turn causes severe channel aging problem. Therefore, novel SRS design methods with enhanced SRS capacity are needed to efficiently handle both the channel aging problem and the intra-/inter-cell cross SRS interference problem.

Thus, embodiments of the present disclosure describe a solution to increase the reference signal capacity in a communication system by Q times over the same time and frequency resources while producing better channel estimation performances than prior art solutions. Embodiments of the present disclosure achieve objectives including alleviating the channel aging problem by enabling the concurrent transmissions of more reference signals per cell to achieve a shorter reference signal transmission period, and solving the inter-cell cross interference problem by enabling the concurrent transmission of the same number of reference signals per cell as Rel-16/Rel-17 SRS over less time frequency resources to allow for the time-frequency resource allocation for the reference signals among adjacent cells to be orthogonal with each other, while without increasing the reference signal transmission period of each cell.

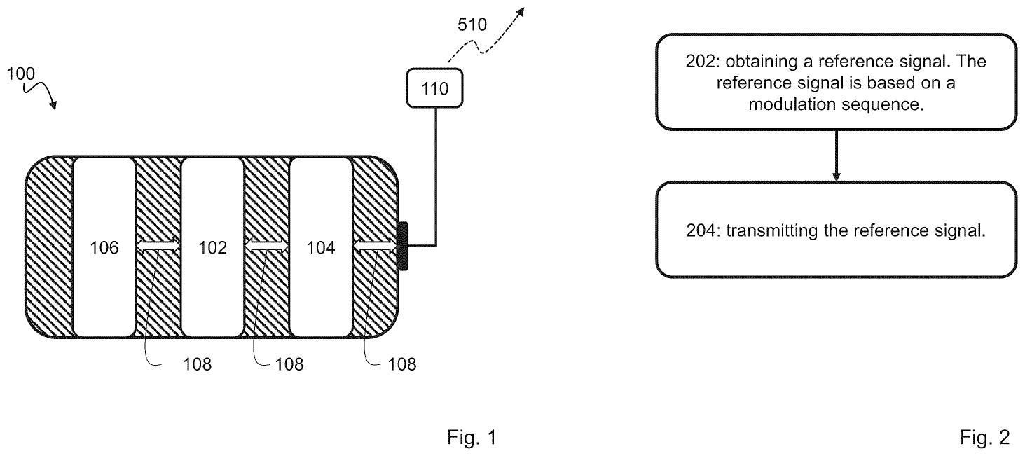

FIG. 1 depicts a first communication device 100 according to an embodiment of the present disclosure. In the embodiment shown in FIG. 1, the first communication device 100 comprises a processor 102, a transceiver 104 and a memory 106. The processor 102 is coupled to the transceiver 104 and the memory 106 by communication means 108 known in the art. The first communication device 100 may be configured for wireless and/or wired communications in a communication system. The wireless communication capability may be provided with an antenna or antenna array 110 coupled to the transceiver 104, while the wired communication capability may be provided with a wired communication interface 112 e.g., coupled to the transceiver 104. The processor 102 may be referred to as one or more general-purpose central processing unit (CPU), one or more digital signal processor (DSP), one or more application-specific integrated circuit (ASIC), one or more field programmable gate array (FPGA), one or more programmable logic device, one or more discrete gate, one or more transistor logic device, one or more discrete hardware component, or one or more chipsets. The memory 106 may be a read-only memory, a random access memory (RAM), or a non-volatile RAM (NVRAM). The transceiver 304 may be a transceiver circuit, a power controller, or an interface providing capability to communicate with other communication modules or communication devices, such as network nodes and network servers. The transceiver 104, memory 106 and/or processor 102 may be implemented in separate chipsets or may be implemented in a common chipset. That the first communication device 100 is configured to perform certain actions can in this disclosure be understood to mean that the first communication device 100 comprises suitable means, such as e.g., the processor 102 and the transceiver 104, configured to perform the actions.

According to embodiments of the present disclosure, the first communication device 100 is configured to obtain a reference signal 510. The reference signal 510 is based on a modulation sequence from a set of QA modulation sequences of length L≥1, the set of QA modulation sequences comprising Q subsets of modulation sequences, Q≥1, each subset of modulation sequences comprising A modulation sequences, A≥1, wherein a correlation between any two reference signals based on any two modulation sequences in a same subset of modulation sequences satisfies a first correlation criterion, wherein a correlation between any two reference signals based on any two modulation sequences in respective any two different subsets of modulation sequences satisfies a second correlation criterion, and wherein the correlation between any two reference signals based on any two modulation sequences in a same subset of modulation sequences is lower than the correlation between any two reference signals based on any two modulation sequences in respective any two different subsets of modulation sequences. The first communication device 100 is further configured transmit the reference signal 510. For example, the reference signal can be obtained by mapping the modulation sequence onto a set of L subcarriers within a given frequency band with a consecutive number N≥L subcarriers to obtain a set of N Fourier coefficients. The obtained set of Fourier coefficients can be converted to the time domain via inverse DFT (IDFT), to yield the time domain reference signal. In addition, when a first communication device 100 has multiple antennas and/or antenna ports to support concurrent transmission of multiple reference signals, the first communication device 100 may be configured to obtain multiple reference signals based on multiple modulation sequences from the set of QA modulation sequences.

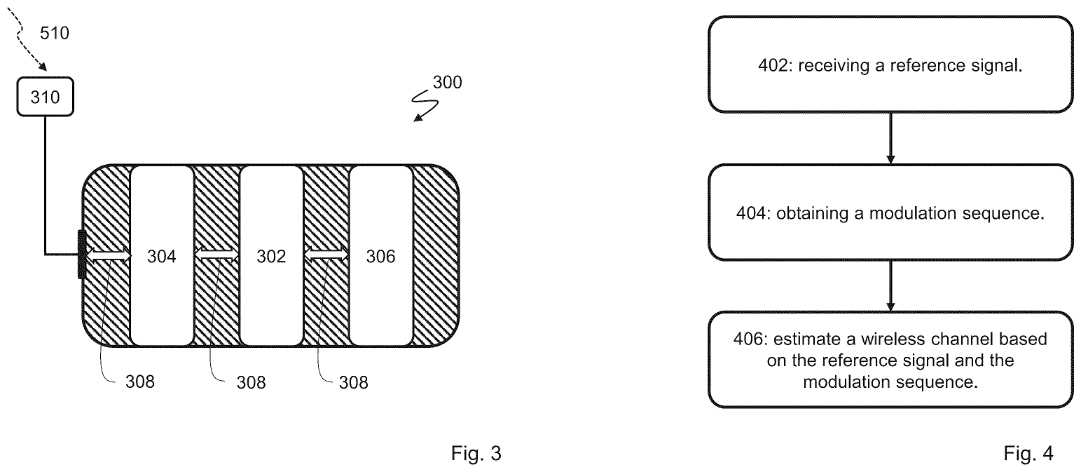

FIG. 2 depicts a flow chart of a corresponding method 200 which may be executed in a first communication device 100, such as the one shown in FIG. 1. The method 200 comprises obtaining 202 a reference signal 510. The reference signal 510 is based on a modulation sequence from a set of QA modulation sequences of length L≥1, the set of QA modulation sequences comprising Q subsets of modulation sequences, Q≥1, each subset of modulation sequences comprising A modulation sequences, A≥1, wherein a correlation between any two reference signals based on any two modulation sequences in a same subset of modulation sequences satisfies a first correlation criterion, wherein a correlation between any two reference signals based on any two modulation sequences in respective any two different subsets of modulation sequences satisfies a second correlation criterion, and wherein the correlation between any two reference signals based on any two modulation sequences in a same subset of modulation sequences is lower than the correlation between any two reference signals based on any two modulation sequences in respective any two different subsets of modulation sequences. The method 200 comprises transmitting 204 the reference signal 510.

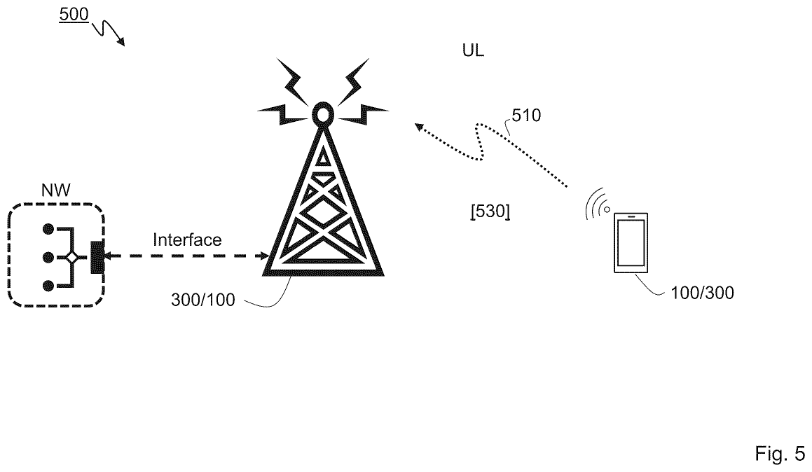

FIG. 3 depicts a second communication device 300 according to an embodiment of the present disclosure. In the embodiment depicted in FIG. 3, the second communication device 300 comprises a processor 302, a transceiver 304 and memory 306. The processor 302 is coupled to the transceiver 304 and the memory 306 by communication means 308 known in the art. The second communication device 300 further comprises an antenna or antenna array 310 coupled to the transceiver 304, which means that the second communication device 300 is configured for wireless communications in a communication system. The processor 302 may be referred to as one or more general-purpose CPU, one or more DSP, one or more ASIC, one or more FPGA, one or more programmable logic device, one or more discrete gate, one or more transistor logic device, one or more discrete hardware component, one or more chipset. The memory 306 may be a read-only memory, a RAM, or a NVRAM. The transceiver 104 may be a transceiver circuit, a power controller, or an interface providing capability to communicate with other communication modules or communication devices. The transceiver 304, the memory 306 and/or the processor 302 may be implemented in separate chipsets or may be implemented in a common chipset. That the second communication device 300 is configured to perform certain actions can in this disclosure be understood to mean that the second communication device 300 comprises suitable means, such as e.g., the processor 302 and the transceiver 304, configured to perform the actions.

According to embodiments of the present disclosure, the second communication device 300 is configured to receive a reference signal 510. The second communication device 300 is further configured to obtain a modulation sequence from a set of QA modulation sequences of length L≥1, the set of QA modulation sequences comprising Q subsets of modulation sequences, Q≥1, each subset of modulation sequences comprising A modulation sequences, A≥1, wherein a correlation between any two reference signals based on any two modulation sequences in a same subset of modulation sequences satisfies a first correlation criterion, wherein a correlation between any two reference signals based on any two modulation sequences in respective any two different subsets of modulation sequences satisfies a second correlation criterion, and wherein the correlation between any two reference signals based on any two modulation sequences in a same subset of modulation sequences is lower than the correlation between any two reference signals based on any two modulation sequences in respective any two different subsets of modulation sequences. The second communication device 300 is further configured to estimate a wireless channel 530 based on the received reference signal 510 and the modulation sequence.

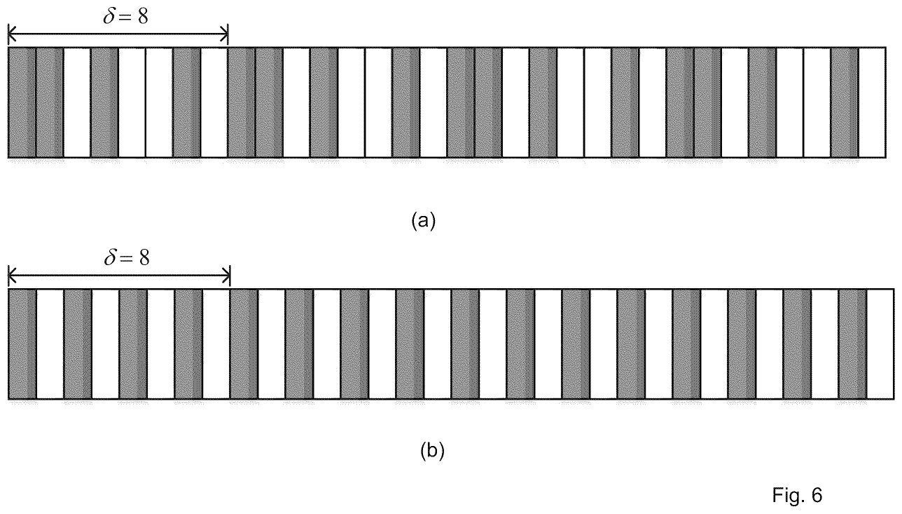

FIG. 4 depicts a flow chart of a corresponding method 400 which may be executed in a second communication device 300, such as the one shown in FIG. 3. The method 400 comprises receiving 402 a reference signal 510. The method 400 further comprises obtaining 404 a modulation sequence from a set of QA modulation sequences of length L≥1, the set of QA modulation sequences comprising Q subsets of modulation sequences, Q≥1, each subset of modulation sequences comprising A modulation sequences, A≥1, wherein a correlation between any two reference signals based on any two modulation sequences in a same subset of modulation sequences satisfies a first correlation criterion, wherein a correlation between any two reference signals based on any two modulation sequences in respective any two different subsets of modulation sequences satisfies a second correlation criterion, and wherein the correlation between any two reference signals based on any two modulation sequences in a same subset of modulation sequences is lower than the correlation between any two reference signals based on any two modulation sequences in respective any two different subsets of modulation sequences. The method 400 further comprises estimating 406 a wireless channel 530 based on the received reference signal 510 and the modulation sequence.

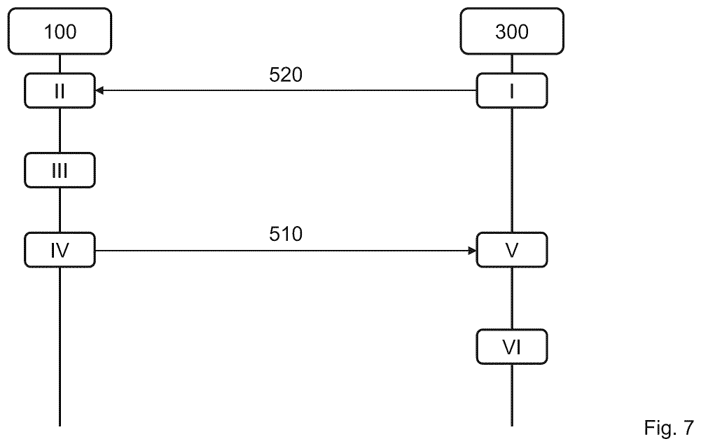

FIG. 5 depicts a communication system 500 according to an embodiment of the present disclosure. The communication system 500 in the disclosed example comprises a first communication device 100 and a second communication device 300 configured to communicate and operate in the communication system 500. For simplicity, the shown communication system 500 only comprises one first communication device 100 and one second communication device 300. However, the communication system 500 may comprise any number of first communication devices 100 and any number of second communication devices 300 without deviating from the scope of the present disclosure.

The first communication device 100 may in non-limiting examples act or be configured as a client device thus communicating with the second communication device 300 acting or being configured as a network access node. The network access node may be part of a radio access network (RAN) which in turn is connected to a network via a suitable communication interface. The network may be a core network which may be connected to external networks of same or other communication system. In such examples, the first communication device 100 transmits reference signals 510 in the UL to the second communication device 300. However, it may be noted that the reverse order is also possible, i.e., that the second communication device 300 act as a client device while the first communication devices 100 act as a network access node. The first communication devices 100 may also be denoted transmitter device or transmitter. Correspondingly, the second communication device 300 may be denoted receiver device or receiver.

In general terms, the first communication device 100 may be configured to perform the following steps:
Step 1: Determine frequency resources Ω̅ₘ for all the reference signals in a set of reference signals;
Step 2: Generate Q subsets of modulation sequences with each subset containing A modulation sequences;
Step 3: Map the modulation sequences to the frequency resources Ω̅ₘ, to obtain Fourier coefficients; and
Step 4: Convert the Fourier coefficients to a time-domain reference signal via IDFT, yielding the set of reference signals.

Steps 1-4 may be performed in any suitable order, e.g., step 2 can be performed before or in parallel with step 1. In the following disclosure further embodiments of the present disclosure will be presented with reference to steps 1-4. These embodiments are set in a 3GPP 5G context for improved understanding of the present disclosure. Thus, implementation examples are described and presented with the use of terminology, expressions and system architecture according to 3GPP 5G NR systems. In the disclosed examples, the first communication device is denoted a UE, the second communication device 300 is denoted a TRP, a BS or a gNB. Further, the present reference signals are herein presented as SRS transmitted from the UE in the UL. However, embodiments of the present disclosure are not limited thereto.

### Frequency Resources

In embodiments of the present disclosure, the first communication device 100 is configured to transmit a reference signal 510 on a set of L subcarriers among N consecutive subcarriers, N≥L, wherein the N consecutive subcarriers are divided into t subbands comprising an equal number of consecutive subcarriers, and wherein the set of L subcarriers comprise A subcarriers from each subband and the positions of the A subcarriers in each subband are the same for all the t subbands.

The SRS frequency band in NR consists of N subcarriers, with frequencies f={f₀, . . . , f_{N-1}} and uniform spacing Δf between neighboring frequencies. Without loss of generality, it can be assumed that f₀=0 and Δf=1, so the totally available frequency resources are denoted as f={0, 1, . . . , N−1}, i.e., referring to the subcarrier frequencies by the corresponding subcarrier indices.

We will assume that N=δt, with δ and t being positive integers, and divide the N subcarriers into t interlacing subbands of δ consecutive subcarriers. Then, each interlacing subband may be further divided into K_{TC}=└δ/A┘ orthogonal generalized physical resource blocks (gPRBs) each containing A (A≤δ) subcarriers, where └x┘ is the greatest integer less than or equal to x.

The indices of the A subcarriers in the m-th (m=0, 1, . . . , K_{TC}−1) gPRB are denoted by {j_{m,l}|l=0, 1, . . . , A−1} satisfying 0≥j_{m,0}<j_{m,1}< . . . <j_{m,A-1}≤δ−1, which can be arbitrarily distributed in the interlacing subband but are the same for all the t interlacing subbands. The set of all t such gPRBs, each selected from one interlacing subband, form an interlace, which is mathematically described as a set of L=At used i.e., allowed subcarrier frequencies Ω̅ₘ (m=0,1, . . . , K_{TC}−1), defined as

$${\overline{Ω}}_{m} = \{ δ i + {j}_{m , l} \vert i = 0 , 1 , … , t - 1 , l = 0 , 1 , … , A - 1 \} . \qquad ( 2 )$$

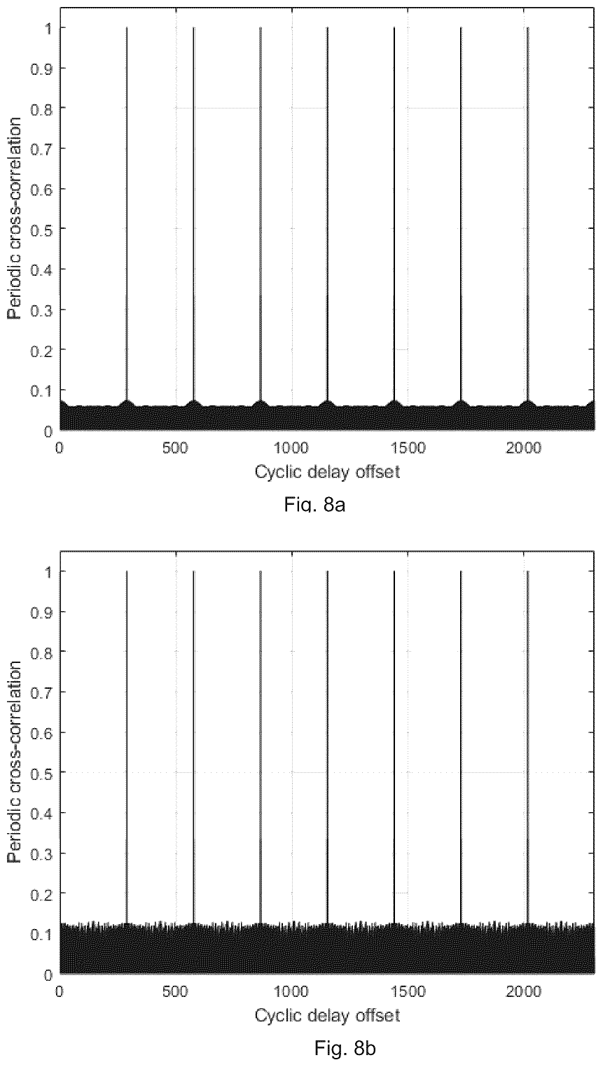

For example, when N=32, δ=8, t=A=4, FIG. 6a shows an exemplary frequency resource allocation with {j_{m,l}}={0, 1, 3, 6}.

Waveforms whose spectrum is defined as in Eq. (2) can be classified as a generalized version of block-interleaved frequency-division multiple access (B-IFDMA) waveforms. A B-IFDMA waveform by structuring the frequency resources of OFDM waveforms, is a base-band analog signal with a comb spectrum, with non-zero DFT coefficients only at discrete frequencies within a certain number of equidistant and identical blocks of uniformly spaced subcarriers. In general, one can construct K_{T}c orthogonal interlaces in given SRS frequency band, where it holds that

$${\overline{Ω}}_{x} ⋂ {\overline{Ω}}_{y} = ϕ if x \neq y , {⋃}_{m = 0}^{{K}_{TC} - 1} {\overline{Ω}}_{m} ⊆ \{ 0 , 1 , … , N - 1 \} . \qquad ( 3 )$$

In an embodiment of the present disclosure, the parameter A can be set to be a factor of S such that K_{TC}=└δ/A┘=δ/A, and the subcarriers in each gPRB can be selected to be every K_{TC}-th subcarrier with the same starting position in each interlacing subband, i.e.,

$${j}_{m , l} = {j}_{m , 0} + {K}_{TC} l , l = 0 , 1 , … , A - 1 \qquad ( 4 )$$

In this case the common frequency resources for an SRS set reduce to the comb structure as in Rel-16/Rel-17 SRSs, and an exemplary frequency resource allocation with N=32, δ=8, t=A=4 is shown in FIG. 6b.

### Modulation Sequences

Each of the QA modulation sequences {c_{q,n}(u)|q=0,1, . . . , Q−1, n=0,1, . . . , A−1,u=0,1, . . . , L−1}, is in embodiments of the present disclosure a constant-envelope sequence of length L=At, constructed as

$${c}_{q , n} ( u ) = {b}_{q , n} ( u mod A ) {\tilde{b}}_{q} ( u mod B ) a ( u ) , u = 0 , 1 , … , L - 1 , L = At \qquad ( 5 )$$

where
   b_{q,n}(l), l=0,1, . . . , A−1, is the n-th (n=0,1, . . . , A−1) constant-envelope sequence of length A in the q-th (q=0,1, . . . , Q−1) orthogonal subset. A sequence may be labeled as a first sequence or as a “short” sequence. All the A short sequences in the q-th orthogonal subset are mutually orthogonal;
   \tilde{b}_{q}(l), l=0, 1, . . . , B−1, is a constant-envelope sequence that is common for the all the SRSs in a same q-th (q=0,1, . . . , Q−1) subset and different for different SRS subsets, whose length B is an integer being both a multiple of the number of SRSs per subset, A, and a factor of the modulation sequence length, L, i.e.,

$$B ∈ \{ {B}^{′} \vert A < {B}^{′} < L , {B}^{′} mod A = 0 , L mod {B}^{′} = 0 \} . \qquad ( 6 )$$

A sequence may be labeled as a second sequence or as a “middle” sequence; and
a(u) is an arbitrary constant-envelope sequence of length L=At. A sequence may be labeled as a third sequence or as a “long” sequence.

Thus, according to embodiments of the present disclosure, at least one modulation sequence in the set of QA modulation sequences is based on a first sequence in a set of first sequences of length A, a second sequence in a set of second sequences of length B≥1 and a third sequence of length L. The set of first sequences comprises Q subsets of first sequences, where each subset of first sequences comprises A constant-envelope sequences, and where all A constant-envelope sequences are mutually orthogonal to each other. The set of second sequences comprises Q constant-envelope sequences, where a correlation between any two second sequences among Q constant-envelope sequences satisfies a third correlation criterion. The third sequence is a constant-envelope sequence. A modulation sequence in the set of QA modulation sequences may be generated based on element-by-element multiplication of a periodic repetition of a first sequence, a periodic repetition of a second sequence and a third sequence. For example, when L=8, A=2 and B=4, a modulation sequence (c(0), c(1), . . . , c(7)) can be represented by a length-A=2 first sequence (b(0), b(1)), a length-B=4 second sequence (\tilde{b}(0), \tilde{b}(1), \tilde{b}(2), \tilde{b}(3)) and a length-L=8 third sequence (a(0), a(1), . . . a(7)) as: (b(0)\tilde{b}(0)a(0), b(1)\tilde{b}(1)a(1), b(0)\tilde{b}(2)a(2), . . . , b(1)\tilde{b}(3)a(3), b(0)b(0)a(4), . . . , b(1)\tilde{b}(3)a(7))

Example construction of first sequences (short sequences): the A first sequences in the q-th (q=0,1, . . . , Q−1) subset {b_{q,n}(l)} are required to be mutually orthogonal to each other, so as to guarantee a ZCZ property among all the A SRSs in the same subset. They can be selected as the set of all columns of an A×A orthogonal matrix, which can be a DFT matrix, a Hadamard matrix, or a matrix with its columns being all the different cyclically shifted versions of a CAZAC sequence of length A (e.g., a ZC sequence with a certain root index when A is a prime number) or a mCAZAC sequence of length A, where a CAZAC sequence of length L=At is called a mCAZAC sequence if it still remains as a CAZAC sequence after being element-by-element multiplied (i.e., modulated) with the t-time periodically extended version of an arbitrary constant-envelope short sequence of length A. The orthogonal matrices for different subsets can be either the same or different, e.g., one can be a DFT matrix and another can be a Hadamard matrix, or they can be constructed from different CAZAC/mCAZAC sequences. In the case when the first sequence is selected as the set of all columns of an A×A DFT matrix, the first sequences are the same as the equidistant phase rotations adopted in Rel-16/Rel-17 SRSs. The A×A orthogonal matrix obtained in any of the above ways can be further multiplied by an arbitrary constant phase factor, or element-by-element multiplied by a length-A constant envelope cover sequence that can be an arbitrary length-A constant envelope sequence, where the constant phase factors/cover sequences for different orthogonal subsets can be either the same or different.

In other words, first sequences in each subset of first sequences are columns of an A×A constant-envelope orthogonal matrix, or may be based on a multiplication between columns of an A×A constant-envelope orthogonal matrix and a cover sequence. The A×A constant-envelope orthogonal matrix is any of: a A×A DFT matrix, a A×A Hadamard matrix, a A×A matrix with its columns being different cyclically shifted versions of a CAZAC sequence of length A including ZC sequence, or a A×A matrix with its columns being different cyclically shifted versions of a mCAZAC sequence of length A. The cover sequence is a constant-envelope sequence of length A that is the same for all the first sequences in each subset of first sequences, and is the same or different for different subsets of first sequences.

Example construction of second sequences (middle sequences): the second sequences {\tilde{b}_{q}(1)}, (q=0,1, . . . , Q−1) for different subsets are required to be different and have a low periodic cross-correlation with each other, i.e., satisfying the third correlation criterion, so as to guarantee a low and sparse cross correlation between any two generated SRSs from different subsets. Due to the low but non-zero periodic cross-correlation between two second sequences for different subsets, their corresponding modulation sequences (and in turn the resultant SRSs) are in general non-orthogonal to each other. As will be described in more detail below, the second sequence length B controls the sparsity of the cross correlation between two SRSs from different subsets, where their periodic cross correlation function is non-zero only at

$$\frac{100 B}{L}$$

percent of all the N delay offset positions, which otherwise cannot be achieved if the second sequence is removed from the modulation sequence design. The second sequence for one subset can be set to be a length-B all “1” sequence, and the second sequence for the other Q−1 subsets can be set to be different CAZAC or mCAZAC sequences of length B, or the periodic extensions of different CAZAC/mCAZAC sequences of length shorter than B, or the truncations of different CAZAC/mCAZAC sequences of length longer than B. In one example, they can be set to be (periodically extended/truncated) ZC sequences with different root indices. The second sequences obtained in any of the above ways can be further multiplied with a constant phase factor that can be either the same or different for different subsets, and/or element-by-element multiplied by a common and arbitrary length-B constant envelope cover sequence. Due to the low periodic cross-correlation property of different CAZAC/mCAZAC sequences, e.g., ZC sequences with different root indices, the Q second sequences constructed by any of the abovementioned methods can be guaranteed to have low correlation in their periodic cross-correlation functions under any cyclic delay offsets. Furthermore, the selection of different (periodically extended/truncated) CAZAC/mCAZAC sequences for the second sequences may lead to different PAPRs of the resultant SRSs. Hence, the second sequences can be optimized to achieve a low PAPR of the resultant SRSs, e.g., by selecting the second sequences as (periodically extended/truncated) ZC sequences with optimized root indices such that low-PAPR SRSs can be obtained.

In embodiments, the second sequence is common for all modulation sequences in a same subset of modulation sequences and different for modulation sequences from different subsets of modulation sequences. The length of the second sequence B is an integer being a multiple of A and a factor of L, and wherein the second sequence is any of: an all “1” sequence of length B, a CAZAC/mCAZAC sequence of length B, a CAZAC/mCAZAC sequence having a length shorter than B that is periodically extended to length B, or a CAZAC/mCAZAC sequence of a length longer than B that is truncated to length B. The third correlation criterion defines that a second sequence in the set of second sequences has a cross-correlation lower than a predetermined threshold to all the cyclically shifted versions of another sequence in the set of second sequences.

Example construction of the third sequence (long sequence): the third sequence a(u) can be set to be a CAZAC or mCAZAC sequence of length L, or the periodic extension of a CAZAC/mCAZAC sequence of length shorter than L, or the truncation of a CAZAC/mCAZAC sequence of length longer than L. In an example, the third sequence can be set to be a (periodically extended/truncated) ZC sequence with a certain root index, and different third sequences can be obtained from different (periodically extended/truncated) ZC sequences with different root indices and used to generated additional SRS sets, which can be for example adopted in different cells of a cellular communication system. Thus, the third sequence is any of: a CAZAC/mCAZAC sequence of length L, a CAZAC/mCAZAC sequence of length shorter than L that is periodically extended to length L, or a CAZAC/mCAZAC sequence of length longer than L that is truncated to length L.

In an embodiment of modulation sequence generation, the first sequences in the one subset are selected to be all columns of an A×A DFT matrix with A=n_{SRS}^{cs,max}, the second sequence for this subset is selected to be the length-B all “1” sequence, and the third sequence is selected to be a periodically extended ZC sequence of a certain root defined for Rel-16/Rel-17 NR SRSs in the standard. In this case when the common frequency resources Ω̅ₘ are selected to form a comb, the generated n_{SRS}^{cs,max} SRSs in this subset are exactly the same at those Rel-16/Rel-17 NR SRSs. Hence, the set of QA reference signals contain the existing Rel-16/Rel-17 NR SRSs in one of its subsets, and therefore are compatible with the existing Rel-16/Rel-17 NR SRSs. In this case, the second sequences for the other Q−1 subsets can be selected among the candidate (periodically extended/truncated) CAZAC/mCAZAC sequences, in particular (periodically extended/truncated) ZC sequences with different root indices, such that low-PAPR SRSs can be obtained.

In an embodiment of modulation sequence generation, the second sequence length is selected to be the maximum integer in the set defined by Eq. (6). In this case, the periodic cross correlation function of two reference signals based on two modulation sequences from different subsets can be kept sparse and in the meanwhile with low correlation values within the LCZ.

In an embodiment of modulation sequence generation, the second sequence length is selected to be the minimum integer in the set defined by Eq. (6) that is no less than a certain predetermined threshold. In this case, the amplitudes of the periodic cross correlation function of two reference signals based on two modulation sequences from different subsets can be kept at satisfactorily low values and in the meanwhile with the sparsest number of nonzero correlation values within the LCZ, which leads to a lower computation complexity in the corresponding CS based channel estimation at the receiver.

### Fourier Coefficients

A sequence of N Fourier coefficients is obtained as

$${S}_{m , q , n} ( f ) = \{ \begin{matrix}{c}_{q , n} ( Ai + l ) , & f = δ i + {j}_{m , l} ∈ {\overline{Ω}}_{m} ; \\ 0 , & otherwise .\end{matrix} \qquad ( 7 )$$

As there are K_{TC} disjoint interlaces film (m=0,1, . . . , K_{TC}−1), up to K_{TC} sets of quasi-orthogonal SRSs can be constructed using the same set of modulation sequences {c_{q,n}(u)}. Since different interlaces are orthogonal to each other by definition, any two SRSs from different interlaces have zero periodic crosscorrelation, and thus can be transmitted in parallel in the same cell without introducing interference to each other.

### Time-Domain SRS

The time-domain SRS {s_{m,q,n}(k)} may be obtained by IDFT of its corresponding Fourier coefficients {S_{m,q,n} (f)}, yielding

$${s}_{m , q , n} ( k ) = \frac{1}{\sqrt{N}} {\sum }_{f = 0}^{N - 1} {S}_{m , q , n} ( f ) {W}_{N}^{- kf} , \qquad ( 8 )$$

$$q = 0 , 1 , … , Q - 1 , n = 0 , 1 , … , A - 1 , k = 0 , 1 , … , N - 1$$

where the scaling constant 1/\sqrt{N} ensures that the sequence {S_{m,q,n}(f)} and the corresponding SRS {s_{m,q,n}(k)} have the same energy E=L.

In an embodiment of the present disclosure, the time-domain SRS {s_{m,q,n}(k)} may be further cyclically shifted before transmission, where the cyclic shift operation is equivalent to perform linear phase rotation to the Fourier coefficients {S_{m,q,n}(f)} after step 3 and then generate the time-domain SRS via IDFT using step 4. In this case, the cyclic shift values for SRSs in the same subset should be the same so as to maintain the ZCZ property between them, and the cyclic shift values for SRSs from different subsets can be different. The advantage of this additional cyclic shift operation is that the delay offset positions of the non-zero periodic cross-correlation values for two SRSs from different subsets can be changed, i.e., cyclically shifted. When such two SRSs are transmitted concurrently through their respective multi-path channels, the estimation of one channel path of the target SRS may happen to receive the interference contributed by an interfering SRS through a certain channel path. By this additional cyclic shift operation, the interference of the interfering SRS can be shifted to another delay offset position and so the channel path of the target SRS can be estimated accurately.

### Alternative Implementations

When the SRS capacity increase factor, Q, is a factor of the middle sequence length, B, one equivalent implementation of Eq. (5) is to re-index and construct all the QA modulation sequences as

$${c}_{n}^{′} ( u ) = {b}_{n}^{′} ( u mod QA ) {\tilde{b}}_{n mod Q}^{′} ( u mod B ) a ( u ) , \qquad ( 9 )$$

$$n = 0 , 1 , … , QA - 1 , u = 0 , 1 , … , L - 1 ,$$

where
   bₙ′(l) is a length-QA sequence obtained by the Kronecker product of a length-A constant envelope sequence b_{(n mod Q),└n/Q┘}(l) and a length-Q constant envelope sequence ξ_{n mod Q(l)}, i.e.,

$${b}_{n}^{′} ( l ) = {b}_{( n mod Q ) , ⌊ n / Q ⌋} ( l mod A ) {ξ}_{n mod Q} ( ⌊ l / Q ⌋ ) \qquad ( 10 )$$

Here all the QA length-A sequences {b_{q,n}(l)}, q=0,1, . . . , Q−1,n=0,1, . . . , A−1 can be constructed in the same way as the first sequence in Eq. (5). All the Q length-Q sequences ξ_{q} (l), q=0,1, . . . , Q−1 can be arbitrary constant envelope sequences, and they can be either the same or different;
\tilde{b}_{q}′ (u mod B) is a length-B constant envelope sequence that is different for different q (q=0,1, . . . , Q−1), which can be constructed in the same way as the second sequence in Eq. (5); and
a(u) is a length-L constant envelope sequence, which can be constructed in the same way as the third sequence in Eq. (5).

The equivalence between the modulation sequence constructions of Eq. (5) and (9) can be justified by substituting Eq. (10) into Eq. (9) and defining ξ_{q}(└u/Q┘)\tilde{b}_{q}′(u mod B)=\tilde{b}_{q}(u mod B), yielding

$${c}_{n}^{′} ( u ) = {b}_{( n mod Q ) , ⌊ n / Q ⌋} ( u mod A ) {ξ}_{n mod Q} ( ⌊ u / Q ⌋ ) {\tilde{b}}_{n mod Q}^{′} ( u mod B ) a ( u ) = {b}_{( n mod Q ) , ⌊ n / Q ⌋} ( u mod A ) {\tilde{b}}_{n mod Q} ( u mod B ) a ( u ) = {c}_{( n mod Q ) , ⌊ n / Q ⌋} ( u ) . \qquad ( 11 )$$

which is the same as Eq. (5).

In one example of the modulation sequences with A=n_{SRS}^{cs,max}, the sequences b_{q,n}(l) and ξ_{q}(l) in (10) are selected to be

$${b}_{q , n} ( l ) = {W}_{{n}_{SRS}^{cs , max}}^{- nl} , ∀ q = 0 , 1 , … , Q and {ξ}_{q} ( l ) = {W}_{{Qn}_{SRS}^{cs , max}}^{- ql} \qquad ( 12 )$$

and the third sequence is selected to be the same as the periodically extended ZC sequence used for Rel-16/Rel-17 NR SRSs, i.e., a(u)=aᵣ (u) in Eq. (1). Then, obtaining

$${b}_{n}^{′} ( l ) = {W}_{{n}_{SRS}^{cs , max}}^{- ⌊ \frac{n}{Q} ⌋ l} {W}_{{Qn}_{SRS}^{cs , max}}^{- ( n mod Q ) l} = {W}_{{Qn}_{SRS}^{cs , max}}^{- ( Q ⌊ \frac{n}{Q} ⌋ + ( n mod Q ) ) l} = {W}_{{Qn}_{SRS}^{cs , max}}^{- nl} \qquad ( 13 )$$

and Eq. (9) can be expressed as

$${c}_{n}^{′} ( u ) = ( {W}_{{Qn}_{SRS}^{cs , max}}^{- nl} a ( u ) \cdot {a}_{r} ( u ) ) \cdot {\tilde{b}}_{n mod Q}^{′} ( u mod B ) , \qquad ( 14 )$$

i.e., the modulation sequences disclosed in the present disclosure can be generated from those of the Rel-16/Rel-17 NR SRSs by first increasing the number of equidistant phase rotations n_{SRS}^{cs,max} by Q times and then element-by-element multiplying with a mask sequence that is the periodically extended version of a second sequence \tilde{b}_{q}′(l) of length-B in the set of Q second sequences.

### Properties of Proposed Reference Signals

In this subsection the periodic auto-/cross-correlation properties for the proposed reference signals are proved.

Periodic auto-correlation: starting from the frequency-domain definition of the periodic autocorrelation function of an SRS {s_{m,q,n}(k)}, the following is obtained

$$( 15 )$$

$${θ}_{{s}_{m , q , n} , {s}_{m , q , n}} ( p ) = {\sum }_{f = 0}^{N - 1} {S}_{m , q , n}^{*} ( f ) {S}_{m , q , n} ( f ) {W}_{N}^{- pf} = {\sum }_{l = 0}^{A - 1} {\sum }_{i = 0}^{t - 1} {c}_{q , n}^{*} ( iA + l ) {c}_{q , n} ( iA + l ) {W}_{N}^{- p ( i δ + {j}_{m , l} )} = {\sum }_{l = 0}^{A - 1} {W}_{N}^{- {pj}_{m , l}} {\sum }_{i = 0}^{t - 1} {W}_{t}^{- pi} = \{ \begin{matrix}E , & p = 0 \\ 0 , & p mod t \neq 0 \\ t {\sum }_{l = 0}^{A - 1} {W}_{δ}^{φ {j}_{m , l}} , & p = t φ , φ = 1 , … , δ - 1\end{matrix} .$$

From Eq. (15) it is concluded that the periodic autocorrelation function of each SRS has a ZAZ of length at least D_{ZAZ}=t−1.

Periodic cross-correlation: for any two SRSs from the same subset s_{m,q,n}(k) and s_{m,q,n}′(k) provides

$$( 16 )$$

$${θ}_{{s}_{m , q , {n}^{′}} , {s}_{m , q , n}} ( p ) = {\sum }_{f = 0}^{N - 1} {S}_{m , q , n}^{*} ( f ) {S}_{m , q , {n}^{′}} ( f ) {W}_{N}^{- pf} = {\sum }_{l = 0}^{A - 1} {\sum }_{i = 0}^{t - 1} {c}_{q , n}^{*} ( iA + l ) {c}_{q , {n}^{′}} ( iA + l ) {W}_{N}^{- p ( i δ + {j}_{m , l} )} = {\sum }_{l = 0}^{A - 1} {\sum }_{i = 0}^{t - 1} {b}_{q , n}^{*} ( l ) {b}_{q , {n}^{′}} ( l ) {W}_{N}^{- p ( i δ + {j}_{m , l} )} = {\sum }_{l = 0}^{A - 1} {b}_{q , n}^{*} ( l ) {b}_{q , {n}^{′}} ( l ) {W}_{N}^{- {pj}_{m , l}} \cdot {\sum }_{i = 0}^{t - 1} {W}_{t}^{- pi} = \{ \begin{matrix}t {\sum }_{l = 0}^{A - 1} {b}_{q , n}^{*} ( l ) {b}_{q , {n}^{′}} ( l ) {W}_{N}^{- {pj}_{m , l}} , & p mod t = 0 ; \\ 0 , & p mod t \neq 0\end{matrix} .$$

In addition, since {b_{q,n}(l)} and {b_{q,n}′(l)} are first sequences in the same orthogonal subset, i.e., Σₗ₌₀^{A-1} b*_{q,n}(l)b_{q,n}′(l)=0, providing

$${θ}_{{s}_{m , q , {n}^{′}} , {s}_{m , q , n}} ( p = 0 ) = t {\sum }_{l = 0}^{A - 1} {b}_{q , n}^{*} ( l ) {b}_{q , {n}^{′}} ( l ) = 0. \qquad ( 17 )$$

Hence, there exists a zero cross-correlation zone (ZCCZ) of length D_{ZCCZ}=t−1. Combining this with Eq. (15), it can be concluded that the SRSs from the same subset have a ZCZ of length D_{ZCZ}=t−1. Thus, the first correlation criterion defines that a reference signal based on a modulation sequence in a subset of modulation sequences is orthogonal to a consecutive number of cyclically shifted versions of another reference signal based on another modulation sequence in the same subset of modulation sequences.

For any two SRSs from the different subsets s_{m,q,n}(k) and s_{m,q′n′}(k), by defining Z=B/A to provide

$$\begin{matrix}{θ}_{{s}_{m , {q}^{′} , {n}^{′}} , {s}_{m , q , n}} ( p ) = {\sum }_{f = 0}^{N - 1} {S}_{m , q , n}^{*} ( f ) {S}_{m , q , {n}^{′}} ( f ) {W}_{N}^{- pf} \\ = {\sum }_{l = 0}^{A - 1} {\sum }_{w = 0}^{Z - 1} {\sum }_{i = 0}^{t / Z - 1} {c}_{q , n}^{*} ( ( iZ + w ) A + l ) {c}_{{q}^{′} , {n}^{′}} ( ( iZ + w ) A + l ) \\ {W}_{N}^{- p ( ( iZ + w ) δ + {j}_{m , l} )} \\ = {\sum }_{l = 0}^{A - 1} {\sum }_{w = 0}^{Z - 1} {\sum }_{i = 0}^{L / B - 1} {b}_{q , n}^{*} ( l ) {\tilde{b}}_{q}^{*} ( wA + l ) {b}_{{q}^{′} , {n}^{′}} ( l ) {\tilde{b}}_{{q}^{′} , {n}^{′}} ( wA + l ) \\ {W}_{N}^{- p ( ( iZ + w ) δ + {j}_{m , l} )} \\ = {\sum }_{l = 0}^{A - 1} {b}_{q , n}^{*} ( l ) {b}_{{q}^{′} , {n}^{′}} ( l ) {W}_{N}^{- {pj}_{m , l}} {\sum }_{w = 0}^{Z - 1} {\tilde{b}}_{q}^{*} ( wA + l ) {\tilde{b}}_{{q}^{′} , {n}^{′}} ( wA + l ) \\ {W}_{t}^{- pw} \\ \cdot {\sum }_{i = 0}^{L / B - 1} {W}_{L / B}^{- pi}\end{matrix} \qquad ( 18 )$$

$$\{ \begin{matrix}\neq 0 & p mod \frac{L}{B} = 0 ; \\ = 0 & p mod \frac{L}{B} = 0\end{matrix} .$$

Hence, the periodic cross-correlation between two SRSs from different subsets are sparse and non-zero only at

$$\frac{100 B}{L}$$

percent of all the N delay offset positions. The values of these non-zero correlations depend on the detailed selections of the frequency resource allocation Ω̅ₘ of the modulation sequences as well as the selections of the first sequences and the second sequences.

In one implementation example, the frequency resource allocation Ω̅ₘ is selected to be a comb as in Eq. (4), the first sequences are selected to be columns of the A×A DFT matrix, i.e., b_{q,n}(l)=W_{A}^{-nl}. Then the first two sums in Eq. (18) can be written as

$${\sum }_{l = 0}^{A - 1} {b}_{q , n}^{*} ( l ) {b}_{{q}^{′} , {n}^{′}} ( l ) {W}_{N}^{- {pj}_{m , l}} {\sum }_{w = 0}^{Z - 1} {\tilde{b}}_{q}^{*} ( wA + l ) {\tilde{b}}_{{q}^{′}} ( wA + l ) {W}_{t}^{- pw} = {\sum }_{l = 0}^{A - 1} {W}_{A}^{nl} {W}_{A}^{- {n}^{′} l} {W}_{N}^{- p ( {j}_{m , 0} + {K}_{TC} l )} {\sum }_{w = 0}^{Z - 1} {\tilde{b}}_{q}^{*} ( wA + l ) {\tilde{b}}_{{q}^{′}} ( wA + l ) {W}_{t}^{- pw} = {W}_{N}^{- {pj}_{m , o}} {\sum }_{l = 0}^{B - 1} {\tilde{b}}_{q}^{*} ( l ) {\tilde{b}}_{{q}^{′}} ( l ) {W}_{L}^{( ( n - {n}^{′} ) t - p ) l} , \qquad ( 19 )$$

which is the over-sampled periodic cross-correlation of the middle sequences \tilde{b}_{q}(l) and \tilde{b}_{q}′(l). When both \tilde{b}_{q}(l) and \tilde{b}_{q}′(l) are selected to be different CAZAC/mCAZAC sequences, e.g., ZC sequences with different root indices, the amplitudes of their periodic cross-correlation function can be about \sqrt{B} at all oversampled delay offset positions. In addition, the third sum in Eq. (18) can be written as

$${\sum }_{i = 0}^{L / B - 1} {W}_{L / B}^{- pi} = \{ \begin{matrix}\frac{L}{B} , & p mod \frac{L}{B} = 0 ; \\ 0 , & p mod \frac{L}{B} \neq 0\end{matrix} . \qquad ( 20 )$$

Consequently, the amplitudes of the periodic cross-correlation function of two SRSs from different subsets can be approximately written as

$$\vert {θ}_{{s}_{m , {q}^{′} , {n}^{′}} , {s}_{m , q , n}} ( p ) \vert \{ \begin{matrix}\approx \frac{L}{B} \cdot \sqrt{B} = \frac{L}{\sqrt{B}} & p mod \frac{L}{B} = 0 ; \\ = 0 , & p mod \frac{L}{B} \neq 0\end{matrix} . \qquad ( 21 )$$

Since the value L/\sqrt{B} is considered to be low when B is sufficiently large, two SRSs generated based on any two modulation sequences from different subsets of modulation sequences have low cross correlation with each other under all cyclically shifted delay offsets. Combining this with the fact that all the A SRSs generated based on all the A modulation sequences in each of the Q subsets of modulation sequence have a ZCZ of length t, it can concluded that all the QA SRSs generated based on the disclosed idea have a LCZ of length t. Thus, the second correlation criterion defines that a reference signal based on a modulation sequence in a subset of modulation sequences has a cross-correlation lower than a predetermined threshold to a consecutive number of cyclically shifted versions of another reference signal based on another modulation sequence in a different subset of modulation sequences.

### Signaling Aspects

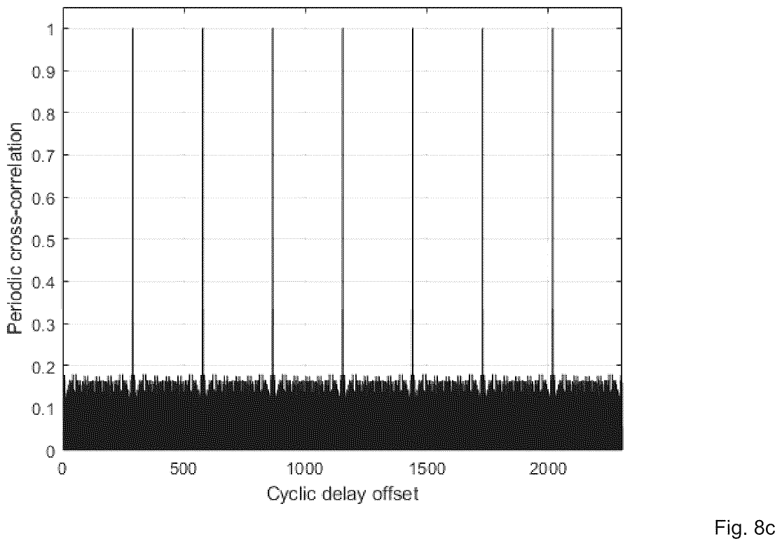

FIG. 7 illustrates some signaling aspect of embodiments of the present disclosure. In step I in FIG. 7, the second communication device 300 transmits a control signal 520 to the first communication device 100. In step II in FIG. 7, the first communication device 100 derives the information in the control signal 520. Based on the information in the control signal 520 the first communication device 100 in step III in FIG. 7 generates one or more reference signals based on one or more modulation sequences. In step IV the first communication device 100 transmits the one or more reference signals to the second communication device 300 which receives the one or more reference signals in step V in FIG. 7. In step VI in FIG. 7, the second communication device 300 estimates the wireless channel between the first communication device 100 and the second communication device 300 based on the received one or more reference signals and the one or more modulation sequences obtained/generated locally. Thus, before a first communication device 100 transmits an SRS in the UL in NR, the first communication device 100 needs to determine the configuration of the SRS to be transmitted from the control signal 520 which may be received in higher layer signaling. The configuration of the SRS may include the SRS time-frequency resource for each SRS antenna port, e.g., the starting position in the time domain, the number of consecutive OFDM symbols in each SRS period, the starting position in frequency domain, the SRS bandwidth and the comb number, etc. The SRS time-frequency resource can be signaled in the same manner as that in 3GPP NR, e.g., through SRS-resource configuration signaling, and the SRS sequence identity nN RScan be signaled in different ways as detailed below. It is noted that the values of S, A and t can be derived from the SRS time-frequency resource configuration, and so do not need to be signaled separately even though that may be possible.

In an embodiment of the present disclosure, when a first communication device 100 needs to transmit SRSs from multiple SRS antenna ports over the same time-frequency resources, all or some of these SRSs are selected from the same orthogonal SRS subset on the same interlace and signaled to the first communication device 100.

In an embodiment of the present disclosure, when a first communication device 100 needs to transmit SRSs from multiple SRS antenna ports over the same time-frequency resources, all or some of these SRSs are selected to have modulation sequences constructed based on first sequences from the same orthogonal first sequence subset and the same second sequence and third sequence, mapped to different interlaces, and then signaled to the first communication device 100.

In an embodiment of the present disclosure, the value of Q, i.e., the number of subsets of modulation sequences in the set of modulation sequences, is a constant pre-specified in the standard and so unnecessary to be signaled. However, in some embodiments of the present disclosure, the value of Q is configurable and can be taken from a number of N_{Q} values {Q₀,Q₁, . . . , Q_{N}_{_{Q}}−1}pre-specified in the standard, and its detailed value is signaled to the UE via a ┌log₂ N_{Q}┐-bit string. Thus, the value of Q is predefined; or the first communication device 100 is configured to receive a control signal 520 indicating the value of Q.

The first communication device 100 may further be configured to receive a control signal 520 indicating an identity of the modulation sequence.

In an embodiment of the present disclosure, the identity of the modulation sequence is indicated by a single bit string of ┌log₂(N_{group}QA)┐ bits, where N_{group} is a number of reference signal groups defined in the communication system (500). In NR, the SRS sequence identity n_{ID}^{SRS} is signaled to the UE by a single bit string of ┌log₂(N_{group}QA)┐ bits, where N_{group} is the number of SRS groups defined in the system (i.e., one group for one cell), Q is the number of orthogonal SRS subsets in each SRS group, and A is the number of orthogonal SRSs within each orthogonal SRS subset.

In an embodiment of the present disclosure, the identity of the modulation sequence is indicated by two bit strings of lengths ┌log₂(N_{group})┐ and ┌log₂(QA)┐, respectively, where the first bit string indicates a reference signal group index, and the second bit string indicates an index of a modulation sequence in a set of modulation sequences associated with the reference signal group index. In NR, the SRS sequence identity n_{IS}^{SRS} is signaled by two bit strings of lengths ┌log₂(N_{group})┐ and ┌log₂(QA)┐, respectively, where the first bit string is used to indicate the SRS group number, and the second bit string is used to indicate the index of the SRS sequence within each SRS group.

In an embodiment of the present disclosure, the identity of the modulation sequence is indicated by three bit strings of length ┌log₂(N_{group})┐, ┌log₂(Q)┐ and ┌log₂(A)┐, respectively, where the first bit string indicates a reference signal group index, the second bit string indicates an index of a subset of modulation sequences in a set of modulation sequences associated with the reference signal group index, and the third bit string indicates an index of a modulation sequence in a subset of modulation sequences. In NR, the SRS sequence identity n_{ID}^{SRS} is signaled by three bit strings of length ┌log₂(N_{group})┐, ┌log₂(Q)┐ and ┌log₂(A)┐, respectively, where the first bit string is used to indicate the SRS group index, the second bit string is used to indicate the index of the orthogonal SRS subset within each SRS group, and the third bit string is used to indicate the index of the SRS within each orthogonal SRS subset.

In an embodiment of the present disclosure, the length B of the second sequence is a constant pre-defined and specified in the standard, or can be derived from the SRS time-frequency resource configuration, and so do not need to be signaled separately. For example, the length B of the second sequence is the maximum integer in the set defined in Eq. (6), or is the minimum integer in the set defined in Eq. (6) that is larger than a certain predetermined threshold, and so can be derived from L and A. In an embodiment, the length B of the second sequence is signaled by a bit string of length ┌log₂(|S_{B}|)┐, where |S_{B}| is the number of elements in the set defined in Eq. (6), or the number of elements in a predefined subset of the set defined in Eq. (6). Thus, a length B of the second sequence is predefined; or the first communication device 100 is configured to receive a control signal 520 indicating the length B of the second sequence. The length B of the second sequence may be indicated by a bit string of length ┌log₂(N_{B})┐ where N_{B} is the number of integers in a set of integers that are a multiple of A and a factor of L, or the number of integers in a predefined subset of the set of integers that are a multiple of A and a factor of L.

### Channel Estimation

The periodic auto-/cross correlation properties introduced in the previous subsection enable a CS based channel estimation for the proposed SRSs when they are transmitted concurrently from the same or different first communication devices with proper TA adjustment, as detailed below.

When all the QA SRSs constructed based on the disclosed method are transmitted concurrently from the same or different first communication devices with proper TA adjustment, the signal received by the second communication device 300 on each subcarrier of the frequency resource allocation Ω̅ₘ can be expressed as

$$Y ( i δ + {j}_{m , l} ) = {\sum }_{q = 0}^{Q - 1} {\sum }_{n = 0}^{A - 1} {S}_{m , q , n} ( i δ + l ) {H}_{q , n} ( i δ + {j}_{m , l} ) + z ( i δ + {j}_{m , l} ) = {\sum }_{q = 0}^{Q - 1} {\sum }_{n = 0}^{A - 1} {c}_{q , n} ( iA + l ) {\sum }_{l = 0}^{{L}_{max} - 1} {W}_{N}^{l ( i δ + {j}_{m , l} )} {h}_{q , n} ( l ) + z ( i δ + {j}_{m , l} ) \qquad ( 22 )$$

where H_{q,n}(f) is the frequency-domain channel coefficient experienced by the SRS s_{m,q,n}(k) on the f-th subcarrier, z(f) is the corresponding noise term, and h_{q,n} (l), l=0,1, . . . , Lₘₐₓ−1 is the time-domain channel coefficient of a channel path experienced by the SRS s_{m,q,n} (k) with time delay l. By collecting the signals received on all the L subcarriers of the frequency resource allocation Ω̅ₘ into a vector, i.e.,

$$y = {( Y ( {j}_{m , 0} ) Y ( {j}_{m , 1} ) Y ( {j}_{m , A - 1} ) Y ( δ + {j}_{m , 0} ) … Y ( ( t - 1 ) δ + {j}_{m , A - 1} ) )}^{T} \qquad ( 23 )$$

which can rewrite Eq. (22) into a matrix form as

$$y = Wh + Z \qquad ( 24 )$$

where Z is the corresponding noise vector, h=(h_{0,0}^{T},h_{0,1}^{T} . . . h_{0,A-1}^{T}h_{1,0}^{T} . . . h_{Q-,A-1})^{T} with h_{q,n}=(h_{q,n}(0) h_{q,n}(1) . . . h_{q,n}(Lₘₐₓ−1))^{T} being the length Lₘₐₓ channel impulse response (CIR) of the channel experienced by s_{m,q,n} (k), and W=(W_{0,0} W_{0,1} . . . W_{0,A-1} W_{1,0} . . . W_{Q-1,A-1}) is a L×QALₘₐₓ matrix with each of its L×Lₘₐₓ submatrix W_{q,n} determined by the SRS sequence {s_{m,q,n} (k)}. The detailed derivation of Eq. (24) can be found in the Appendix. Further denote by w_{q,n,l} the l-th (l=0,1, . . . , Lₘₐₓ−1) column of the submatrix W_{q,n}. As detailed in the Appendix, the normalized correlation between any two columns of W satisfies

$$\frac{{w}_{q , n , l}^{H} {w}_{{q}^{′} , {n}^{′} , {l}^{′}}}{N / {K}_{TC}} \{ \begin{matrix}= 0 , & q = {q}^{′} , n = {n}^{′} , l \neq {l}^{′} \\ = 0 , & q = {q}^{′} , n \neq {n}^{′} \\ = 0 , & q \neq {q}^{′} , {l}^{′} = l mod \frac{L}{B} \neq 0 , \\ \approx \frac{1}{\sqrt{B}} , & q \neq {q}^{′} , {l}^{′} = l mod \frac{L}{B} = 0\end{matrix} \qquad ( 25 )$$

provided that the maximum delay of the channels experienced by all SRSs satisfies Lₘₐₓ≤t.

Eq. (25) implies that W has a low inter-column correlation as long as the value of B is large. In addition, since the length-QALₘₐₓ vector h, which is the concatenation of the CIRs experienced by all the QA SRSs, is usually sparse and contains a much less number of non-zero entries than the vector length QALₘₐₓ, the estimation of the sparse CIRs from Eq. (24) can be regarded as a CS problem and solved using proper CS based algorithms, e.g., orthogonal matching pursuit (OMP).

In addition, from Eq. (25) it is also seen that two columns w_{q,n,l} and w_{q′,n′,l′} are non-orthogonal only when the corresponding two SRSs are from different subsets and

$$l mod \frac{L}{B} = 0.$$

This implies that the matrix W can be regarded as the interleaved concatenation of L/B mutually orthogonal submatrices each with approximately equal numbers of columns. Consequently, the whole CS-based channel estimation problem in Eq. (24) can be decomposed into L/B smaller CS problems and solved in parallel, which reduces the computational complexity.

The disclosed QO SRS scheme can increase the SRS capacity by Q times at the cost of introducing the intra-cell interference among the SRSs transmitted in the same cell, which is similar to conventional solutions. However, there is no corresponding treatment at the receiver for conventional solutions to solve this intra-cell interference problem. As a comparison, the disclosed QO SRS scheme can carefully control the interference between SRSs from different subsets at a low level such that CS based channel estimation can be applied at the receiver to separate the intra-cell interference between SRSs. Hence, a better channel estimation performance, and in turn a better block error rate (BLER)/throughput performance in the subsequent DL data transmission than those of the conventional solutions is provided, as will be shown in the next section.

### Performance Evaluation

The performance of the disclosed QO SRS design is evaluated and compared to conventional solutions under the following system scenario:
A single-cell system at 3.5 GHz carrier frequency with a bandwidth of N=2304 consecutive subcarriers and 30 kHz SCS is considered.
A uniform rectangular antenna array with 4 rows and 8 columns is equipped at the BS (i.e., 32 BS antennas) with half-wavelength spacing between adjacent columns and rows, and a single antenna is assumed at each UE.
The channel between each UE and the BS is generated according to the CDL-C model in 3GPP TS 38.901 V15.0.0, “Study on channel model for frequencies from 0.5 to 100 GHz” assuming 300 ns desired delay spread (corresponding to a CIR length of 180 samples) with random angle of arrival/departure (AoA/AoD) rotations and a random timing error uniformly distributed in [−9 9] samples. The UE speed is set at 30 km/h with arbitrary moving directions in the 2-D plane for each UE, to model the channel aging across OFDM symbols.
The slot pattern of “DDDSU” is assumed to coordinate the UL/DL transmissions, where “D”, “U” and “S” represent a DL slot, UL slot and special slot, respectively, each containing 14 consecutive OFDM symbols, and the SRS transmission is allowed only in the last OFDM symbol of the “S” slot, i.e., the minimum SRS period is 2.5 ms, corresponding to 5 slots each 0.5 ms long.
The SRS powers received from different UEs are assumed to be the same at the BS due to UL power control that compensates for the path loss of different UEs in order to achieve the same sounding accuracy.
Only the DL data transmission of one target UE is simulated assuming perfect channel knowledge at UE side, i.e., there is no scheduling and no interference from data stream for other UEs. The MCS defined by QPSK modulation and rate R=1/2 LDPC code is adopted by the UE for the data transmission in each DL OFDM symbol. The DL SNR is assumed to be the same as the UL SNR.

The disclosed QO SRSs and the conventional SRS schemes are adopted as follows to generate SRSs over the same frequency resources allocations, so as to make a fair comparison between them:
NR SRS (baseline scheme): Considering the maximum channel delay and timing error in the above system setting, taking the Rel-16 NR SRSs with Comb-2 based frequency resource allocation and n_{SRS}^{cs,max}=4 SRSs per comb as reference, such that a total of 8 concurrent SRSs are generated with a ZCZ of length

$${D}_{ZCZ} = \frac{N}{{n}_{SRS}^{cs , max} {K}_{TC}} = \frac{2304}{4 \times 2} = 2 \; 88 > {L}_{max} = 180 + 2 \times 9 = 198$$

to support orthogonal transmission among SRSs. Consequently, the conventional matched filtering and window-based channel estimation is adopted at the receiver with a window length equal to D=min {D_{ZCZ}, Lₘₐₓ}=198.
Conventional solution 2: The Rel-16 NR SRSs with Comb-2 based frequency resource allocation and n_{SRS}^{cs,max}Q=4Q equidistant phase rotations per comb are considered, which generates a total of 8Q SRSs with a ZCZ of length

$${D}_{ZCZ} = \frac{N}{{n}_{SRS}^{cs , max} {K}_{TC} Q} = \frac{288}{Q} .$$

Consequently, the conventional matched filtering and window-based channel estimation is adopted at the receiver with a window length equal to

$$D = min \{ {D}_{ZCZ} , {L}_{max} \} = \frac{288}{Q} .$$

Conventional solution 3: The frequency resource allocation is selected to be the same as Comb-2 by letting δ=8, A=n_{SRS}^{cs,max}=4, t=288 and distributing the A=4 subcarriers in each gPRB to be every other subcarrier in each interlacing subband. A total of 8Q SRSs are generated by generating the modulation sequence as follows: the modulation sequence is generated by element-by-element multiplication of a periodically repeated short sequence and a long sequence, where the long sequence is selected to be the same as the periodically extended ZC sequence used for Rel-16 NR SRS, i.e., a(u)=aᵣ(u), and the short sequence is selected to be the columns of the 4×4 DFT matrix covered by a length-A=4 subset specific cover sequence, i.e., b_{q,n}(l)=Wₙ_{_{SRS}}_{^{cs,max}}^{-nl}. \tilde{b}_{q}(l), where the cover sequence is selected to be a length-4 all “1” sequence for one subset, and length-5 ZC sequences with different root indices punctured to length A=4 for the other Q−1 subsets. The generated A time-domain SRSs in the q-th SRS subset are further cyclically shifted by a same number of

$$\frac{qN}{{Qn}_{SRS}^{cs , max} {K}_{TC}}$$

samples, such that the total generated QA SRSs have a ZCZ of length

$${D}_{ZCZ} = \frac{N}{{n}_{SRS}^{cs , max} {K}_{TC} Q} = \frac{288}{Q} .$$

Consequently, the conventional matched filtering and window-based channel estimation is adopted at the receiver with a window length equal to

$$D = min \{ {D}_{ZCZ} , {L}_{max} \} = \frac{288}{Q} .$$

QO SRSs: The frequency resource allocation is selected to be the same as Comb-2 by letting δ=8, A=n_{SRS}^{cs,max}=4, t=288 and distributing the A=4 subcarriers in each gPRB to be every other subcarrier in each interlacing subband. A total of 8Q SRSs are generated by generating the modulation sequences as follows: select the short and long sequences to be the same as the equidistant phase rotation and periodically extended ZC sequences used for Rel-16 NR SRSs, i.e., b_{q,n}(l)=Wₙ_{_{SRS}}_{^{cs,max}}^{-nl} and a(u)=aᵣ(u), and select the middle sequence to be length-B all “1” sequence for the first subset and periodically extended ZC sequences of length being the largest prime integer no larger than B and different root indices for the other Q−1 subsets. The CS based channel estimation is adopted at the receiver.

It is noted that the SRSs generated by all the above SRS schemes can be transmitted over a partial of the frequency band of which the channel needs to be estimated, i.e., they can be implemented together with the Rel-17 partial SRS in conventional solution 1 to achieve better performance than the pure partial SRS scheme. Hence, the performance of conventional solution 1, i.e., Rel-17 partial SRS, is not included here.

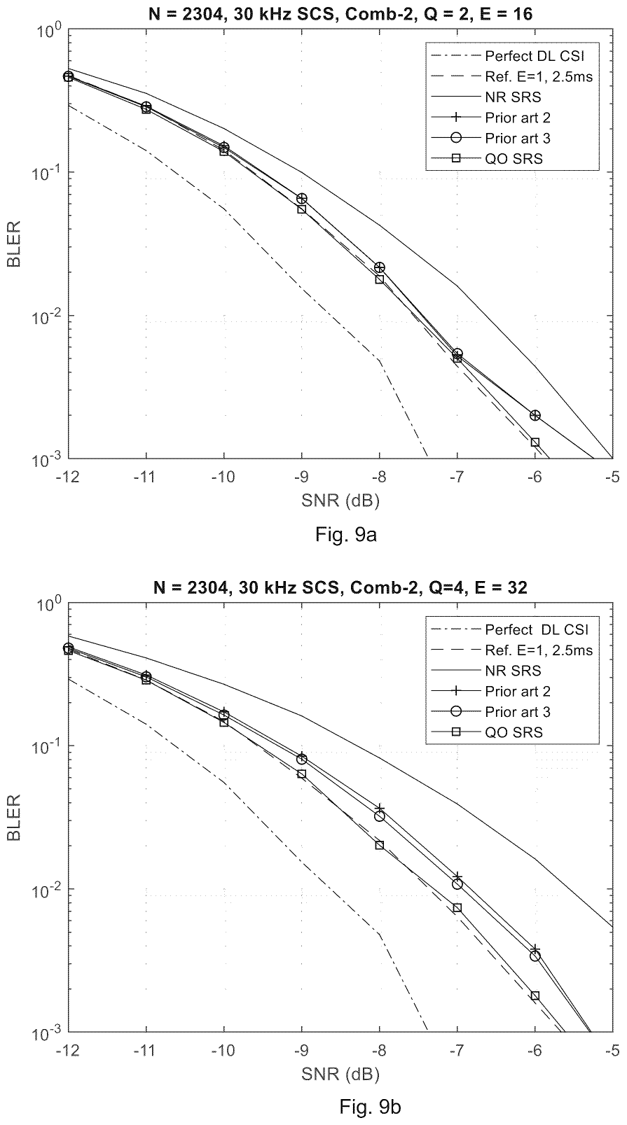

It is considered achieving Q=2, 4 and 8 times of the SRS capacity enhancement using different SRS schemes, and assume there are E=8Q UEs in the cell. With the reference Rel-16 SRSs, at most 8 concurrent SRSs can be supported in one OFDM symbol and so the SRS period is set at 2.5Q ms. All the other schemes can support 8Q concurrent SRSs in one OFDM symbol and so can have 2.5 ms SRS period. FIGS. 8a-8c plot the periodic auto-/cross-correlation functions of the disclosed QO SRS with different values of Q. It can be seen that all the generated QO SRSs have a LCZ of length t=288. The amplitudes of the non-zero cross correlations with in the LCZ are at the level of about 0.06, 0.11 and 0.16 for Q=2, 4 and 8, which are slightly higher than the corresponding expected values of

$$\frac{1}{\sqrt{B}} = 0.059 ,$$

0.833 and 0.118, respectively.

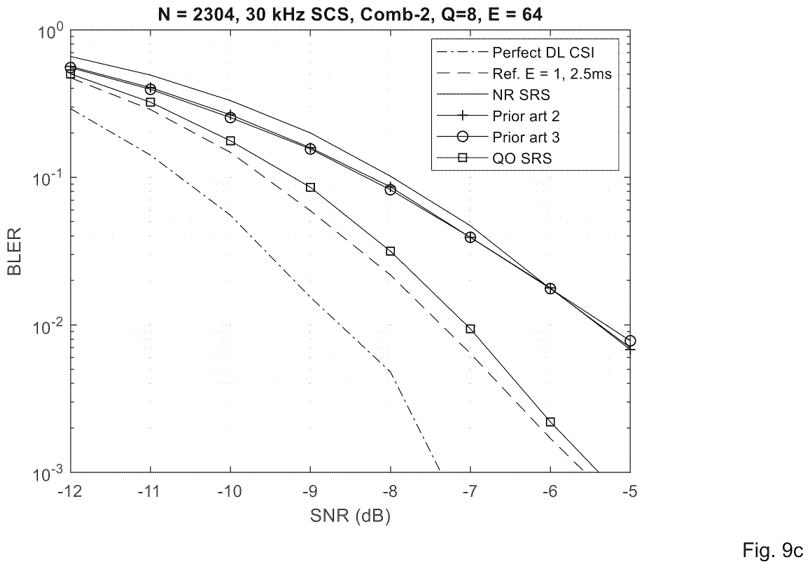

FIGS. 9a-9c plot the BLER performance achieved by different SRS schemes under different numbers of Q SRS capacity enhancements. For convenience, the BLER performance achieved by perfect DL CSI is also included, marked with “perfect DL CSI”, where the DL precoding is designed based on the perfect DL CSI, as well as the BLER performance achieved by a single Rel-16 NR SRS transmission with the minimum 2.5 ms SRS period, marked with “Ref. E=1, 2.5 ms”, where the SRS suffers only the minimum channel aging problem and noise at the receiver without any interference from other SRSs. From FIGS. 9a-9c it can be seen that the disclosed QO SRS scheme outperforms all the other SRS schemes, and the performance gain is more significant when the number of SRS capacity enhancement Q is large. This is because besides the alleviation of the channel aging problem by supporting a short SRS period with SRS capacity enhancement, the QO SRS scheme also efficiently solves the cross-SRS interference problem by utilizing the low correlation property of the generated SRSs in the channel estimation based on CS principle, while the other SRS schemes still suffer the cross-SRS interference problem especially when the number of SRS capacity enhancement Q is large.

### APPENDIX

From Eq. (22), the received signal vector Y in Eq. (23) can be expressed as

$$Y = {\sum }_{q = 0}^{Q - 1} {\sum }_{n = 0}^{A - 1} {W}_{q , n} {h}_{q , n} + Z \qquad ( A1 )$$

where W_{q,n} is a L×Lₘₐₓ matrix, whose entry in the (iA+1)-th row and l′-th column is given by

$${w}_{q , n} ( iA + l , {l}^{′} ) = {c}_{q , n} ( iA + l ) {W}_{N}^{{l}^{′} ( i δ + {j}_{m , l} )} . \qquad ( A2 )$$

By further defining W=(W_{0,0} W_{0,1} . . . W_{0,A-1} W_{1,0} . . . W_{Q-1,A-1}) and h=(h_{0,0}^{T}h_{0,1}^{T} . . . h_{0,A-1}h_{1,0}^{T} . . . h_{Q-1,A-1}^{T})^{T}, one can express (A1) into a more compact form as in (24).

For any two columns of matrix W, e.g., the l₁-th column of the submatrix W_{q,n}, w_{q,n,l}_{₁}, and the l₂-th column of the submatrix W_{q′,n′}, w_{q′,n′,l}_{₂}, provides

$$( A3 )$$

$${w}_{q , n , {l}_{1}}^{H} {w}_{{q}^{′} , {n}^{′} , {l}_{2}} = {\sum }_{i = 0}^{t - 1} {\sum }_{l = 0}^{A - 1} {w}_{q , n}^{*} ( iA + l , {l}_{1} ) {w}_{{q}^{′} , {n}^{′}} ( iA + l , {l}_{2} ) = {\sum }_{i = 0}^{t - 1} {\sum }_{l = 0}^{A - 1} {c}_{q , n}^{*} ( iA + l ) {c}_{{q}^{′} , {n}^{′}} ( iA + l ) {w}_{N}^{- ( {l}_{1} - {l}_{2} ) ( i δ + {j}_{m , l} )} = {\sum }_{f = 0}^{N - 1} {S}_{m , q , n}^{*} ( f ) {S}_{m , {q}^{′} , {n}^{′}} ( f ) {W}_{N}^{- ( {l}_{1} - {l}_{2} ) f} = {θ}_{{s}_{m , {q}^{′} , {n}^{′}} , {s}_{m , q , n}} ( {l}_{1} - {l}_{2} ) .$$

By substituting the periodic auto-/cross-correlation property of the generated SRS in Eq. (15)-(21) into Eq. (A3), Eq. (25) is obtained.

A network access node herein may also be denoted as an access point (AP), or a BS, e.g., a radio BS (RBS), which in some networks may be referred to as transmitter, “gNB”, “gNodeB”, “eNB”, “eNodeB”, “NodeB” or “B node”, depending on the standard, technology and terminology used. The network access node may be of different classes or types such as e.g., macro eNodeB, home eNodeB or pico base station, based on transmission power and thereby the cell size. The network access node may further be a station (STA), which is any device that contains an IEEE 802.11-conformant media access control (MAC) and physical layer (PHY) interface to the wireless medium (WM). The network access node may be configured for communication in 3GPP related long term evolution (LTE), LTE-advanced, fifth generation (5G) wireless systems, such as NR and their evolutions, as well as in IEEE related Wi-Fi, worldwide interoperability for microwave access (WiMAX) and their evolutions.

A client device herein may be denoted as a user device, a UE, a mobile station, an internet of things (IoT) device, a sensor device, a wireless terminal and/or a mobile terminal, and is enabled to communicate wirelessly in a wireless communication system, sometimes also referred to as a cellular radio system. The UEs may further be referred to as mobile telephones, cellular telephones, computer tablets or laptops with wireless capability. The UEs in this context may be, for example, portable, pocket-storable, hand-held, computer-comprised, or vehicle-mounted mobile devices, enabled to communicate voice and/or data, via a RAN, with another communication entity, such as another receiver or a server. The UE may further be a STA, which is any device that contains an IEEE 802.11-conformant MAC and PHY interface to the WM. The UE may be configured for communication in 3GPP related LTE, LTE-advanced, 5G wireless systems, such as NR, and their evolutions, as well as in IEEE related Wi-Fi, WiMAX and their evolutions.

Furthermore, any method according to embodiments of the present disclosure may be implemented in a computer program, having code means, which when run by processing means causes the processing means to execute the steps of the method. The computer program is included in a non-transitory, tangible, computer readable medium of a computer program product. The computer readable medium may comprise essentially any memory, such as previously mentioned a ROM, a PROM, an EPROM, a flash memory, an EEPROM, or a hard disk drive.

In embodiments, the first communication device 100 and the second communication device 300 comprise the necessary communication capabilities in the form of e.g., functions, means, units, elements, etc., for performing or implementing embodiments of the present disclosure. Examples of other such means, units, elements and functions are: processors, memory, buffers, control logic, encoders, decoders, rate matchers, de-rate matchers, mapping units, multipliers, decision units, selecting units, switches, interleavers, de-interleavers, modulators, demodulators, inputs, outputs, antennas, amplifiers, receiver units, transmitter units, DSPs, TCM encoder, TCM decoder, power supply units, power feeders, communication interfaces, communication protocols, etc. which are suitably arranged together for performing the solution.

Therefore, the processor(s) of the first communication device 100 and the second communication device 300 may comprise, e.g., one or more instances of a CPU, a processing unit, a processing circuit, a processor, an ASIC, a microprocessor, or other processing logic that may interpret and execute instructions. The expression “processor” may thus represent a processing circuitry comprising a plurality of processing circuits, such as e.g., any, some or all of the ones mentioned above. The processing circuitry may further perform data processing functions for inputting, outputting, and processing of data comprising data buffering and device control functions, such as call processing control, user interface control, or the like.

1. A first communication device comprising at least one processor, and one or more memories coupled to the at least one processor and storing programming instructions for execution by the at least one processor to perform operations comprising:
obtaining a reference signal, wherein the reference signal is based on a modulation sequence from a set of QA modulation sequences of length L≥1, the set of QA modulation sequences comprising Q subsets of modulation sequences, Q≥1, each subset of the modulation sequences comprising A modulation sequences, A≥1, wherein a correlation between any two reference signals based on any two modulation sequences in a same subset of modulation sequences satisfies a first correlation criterion, wherein a correlation between any two reference signals based on any two modulation sequences in respective any two different subsets of modulation sequences satisfies a second correlation criterion, and wherein the correlation between any two reference signals based on any two modulation sequences in the same subset of modulation sequences is lower than the correlation between any two reference signals based on any two modulation sequences in respective any two different subsets of modulation sequences; and
transmitting the reference signal.

2. The first communication device according to claim 1, wherein the first correlation criterion defines that a reference signal based on a modulation sequence in a subset of modulation sequences is orthogonal to a consecutive number of cyclically shifted versions of another reference signal based on another modulation sequence in the same subset of modulation sequences.

3. The first communication device according to claim 1, wherein the second correlation criterion defines that a reference signal based on a modulation sequence in a subset of modulation sequences has a cross-correlation lower than a predetermined threshold to a consecutive number of cyclically shifted versions of another reference signal based on another modulation sequence in a different subset of modulation sequences.

4. The first communication device according to claim 1, wherein at least one modulation sequence in the set of QA modulation sequences is based on a first sequence in a set of first sequences of length A, a second sequence in a set of second sequences of length B≥1, and a third sequence of length L, wherein the set of first sequences comprises Q subsets of first sequences, each subset of the first sequences comprising A constant-envelope sequences, where all the A constant-envelope sequences are mutually orthogonal to each other, wherein the set of second sequences comprises Q constant-envelope sequences, where a correlation between any two second sequences among the Q constant-envelope sequences satisfies a third correlation criterion, and wherein the third sequence is a constant-envelope sequence.

5. The first communication device according to claim 4, wherein a modulation sequence in the set of QA modulation sequences is based on element-by-element multiplication of a periodic repetition of the first sequence, a periodic repetition of the second sequence and the third sequence.

6. The first communication device according to claim 4, wherein first sequences in each subset of the first sequences are columns of an A×A constant-envelope orthogonal matrix, or based on element-by-element multiplication between columns of the A×A constant-envelope orthogonal matrix and a cover sequence, wherein the A×A constant-envelope orthogonal matrix include at least one of: a A×A discrete Fourier transform (DFT) matrix, a A×A Hadamard matrix, a A×A matrix with its columns being different cyclically shifted versions of a constant-amplitude zero-correlation correlation (CAZAC) sequence of length A including Zadoff-Chu (ZC) sequence, or a A×A matrix with its columns being different cyclically shifted versions of a modulable CAZAC (mCAZAC)sequence of length A, and wherein the cover sequence is a constant-envelope sequence of length A that is the same for all the first sequences in each subset of the first sequences, and is the same or different for different subsets of the first sequences.

7. The first communication device according to claim 6, wherein the second sequence is common for all modulation sequences in a same subset of modulation sequences and different for modulation sequences from different subsets of modulation sequences, where the length of the second sequence B is an integer being a multiple of A and a factor of L, and wherein the second sequence includes at least one of an all “1” sequence of the length B, a CAZAC/mCAZAC sequence of the length B, a CAZAC/mCAZAC sequence having a length shorter than B that is periodically extended to the length B, or a CAZAC/mCAZAC sequence of a length longer than B that is truncated to the length B.

8. The first communication device according to claim 4, wherein
the length B of the second sequence is predefined; or
wherein the operations further comprise receiving a control signal indicating the length B of the second sequence, wherein the length B of the second sequence is indicated by a bit string of length ┌log₂(N_{B})┐, wherein an operator ┌x┐ returns a minimum integer that is no less than x, and N_{B} is the number of integers in a set of integers that are a multiple of A and a factor of L, or the number of integers in a predefined subset of the set of integers that are a multiple of A and a factor of L.

9. The first communication device according to claim 4, wherein the third correlation criterion defines that the second sequence in the set of second sequences has a cross-correlation lower than a predetermined threshold to all the cyclically shifted versions of another second sequence in the set of second sequences.

10. A second communication device comprising at least one processor, and one or more memories coupled to the at least one processor and storing programming instructions for execution by the at least one processor to perform operations comprising:
receiving a reference signal;
obtaining a modulation sequence from a set of QA modulation sequences of length L≥1, the set of QA modulation sequences comprising Q subsets of modulation sequences, Q≥1, each subset of modulation sequences comprising A modulation sequences, A≥1, wherein a correlation between any two reference signals based on any two modulation sequences in a same subset of modulation sequences satisfies a first correlation criterion, wherein a correlation between any two reference signals based on any two modulation sequences in respective any two different subsets of modulation sequences satisfies a second correlation criterion, and wherein the correlation between any two reference signals based on any two modulation sequences in the same subset of modulation sequences is lower than the correlation between any two reference signals based on any two modulation sequences in respective any two different subsets of modulation sequences; and
estimating a wireless channel based on the received reference signal and the modulation sequence.

11. The second communication device according to claim 10, wherein the first correlation criterion defines that a reference signal based on a modulation sequence in a subset of modulation sequences is orthogonal to a consecutive number of cyclically shifted versions of another reference signal based on another modulation sequence in the same subset of modulation sequences.

12. The second communication device according to claim 10, wherein the second correlation criterion defines that a reference signal based on a modulation sequence in a subset of modulation sequences has a cross-correlation lower than a predetermined threshold to a consecutive number of cyclically shifted versions of another reference signal based on another modulation sequence in a different subset of modulation sequences.

13. The second communication device according to claim 10, wherein at least one modulation sequence in the set of QA modulation sequences is based on a first sequence in a set of first sequences of length A, a second sequence in a set of second sequences of length B≥1 and a third sequence of length L, wherein the set of first sequences comprises Q subsets of first sequences, each subset of the first sequences comprising A constant-envelope sequences, where all the A constant-envelope sequences are mutually orthogonal to each other, wherein the set of second sequences comprises Q constant-envelope sequences, where a correlation between any two second sequences among the Q constant-envelope sequences satisfies a third correlation criterion, and wherein the third sequence is a constant-envelope sequences.

14. The second communication device according to claim 10, wherein a modulation sequence in the set of QA modulation sequences is based on element-by-element multiplication of a periodic repetition of the first sequence, a periodic repetition of the second sequence and the third sequence.

15. The second communication device according to claim 10, wherein first sequences in each subset of the first sequences are columns of an A×A constant-envelope orthogonal matrix, or based on element-by-element multiplication between columns of an the A×A constant-envelope orthogonal matrix and a cover sequence, wherein the A×A constant-envelope orthogonal matrix includes at least one of: a A×A discrete Fourier transform (DFT) matrix, a A×A Hadamard matrix, a A×A matrix with its columns being different cyclically shifted versions of a constant-amplitude zero-correlation correlation (CAZAC) sequence of length A including Zadoff-Chu (ZC) sequence, or an A×A matrix with its columns being different cyclically shifted versions of a modulable CAZAC (mCAZAC) sequence of length A, and wherein the cover sequence is a constant-envelope sequence of length A that is the same for all the first sequences in each subset of the first sequences, and is the same or different for different subsets of the first sequences.

16. The second communication device according to claim 15, wherein the second sequence is common for all modulation sequences in a same subset of modulation sequences and different for modulation sequences from different subsets of modulation sequences, where the length of the second sequence B is an integer being a multiple of A and a factor of L, and wherein the second sequence includes at least one of an all “1” sequence of the length B, a CAZAC/mCAZAC sequence of the length B, a CAZAC/mCAZAC sequence having a length shorter than B that is periodically extended to the length B, or a CAZAC/mCAZAC sequence of a length longer than B that is truncated to the length B.

17. The second communication device according to claim 13, wherein
the length B of the second sequence is predefined; or
wherein the operations further comprise transmitting a control signal indicating the length B of the second sequence, wherein the length B of the second sequence is indicated by a bit string of length ┌log₂(N_{B})┐, where N_{B} is the number of integers in a set of integers that are a multiple of A and a factor of L, or the number of integers in a predefined subset of the set of integers that are a multiple of A and a factor of L.

18. The second communication device according to claim 13, wherein the third correlation criterion defines that the second sequence in the set of second sequences has a cross-correlation lower than a predetermined threshold to all the cyclically shifted versions of another second sequence in the set of second sequences.

19. A method for a first communication device, the method comprising:
obtaining a reference signal, wherein the reference signal is based on a modulation sequence from a set of QA modulation sequences of length L≥1, the set of QA modulation sequences comprising Q subsets of modulation sequences, Q≥1, each subset of the modulation sequences comprising A modulation sequences, A≥1, wherein a correlation between any two reference signals based on any two modulation sequences in a same subset of modulation sequences satisfies a first correlation criterion, wherein a correlation between any two reference signals based on any two modulation sequences in respective any two different subsets of modulation sequences satisfies a second correlation criterion, and wherein the correlation between any two reference signals based on any two modulation sequences in the same subset of modulation sequences is lower than the correlation between any two reference signals based on any two modulation sequences in respective any two different subsets of modulation sequences; and
transmitting the reference signal.
